(19) United States
(12) Patent Application Publication
(10) Pub. No.: US 2002/0160196 A1
(43) Pub. Date: Oct. 31, 2002

(54) Microspheres of metal oxides and methods

(75) Inventors: Peter W. Carr, Minneapolis, MN (US); Alon V. McCormick, Minneapolis, MN (US); Bingwen Yan, Shoreview, MN (US); Clayton V. McNeff, Anoka, MN (US); Fang Chen, St. Paul, MN (US)

Correspondence Address: MUETING, RAASCH & GEBHARDT, P.A., P.O. BOX 581415, MINNEAPOLIS, MN, 55458, US

(73) Assignee: Regents of the University of Minnesota, Minneapolis, MN (US)

(21) Appl. No.: 10/012,757

(22) Filed: Oct. 29, 2001

Related U.S. Application Data
(60) Provisional application No. 60/244,041, filed on Oct. 28, 2000.
(60) Provisional application No. 60/248,132, filed on Nov. 13, 2000.
(60) Provisional application No. 60/248,189, filed on Nov. 14, 2000.
(60) Provisional application No. 60/249,307, filed on Nov. 16, 2000.

(51) Int. Cl. C01B 13/32

(52) U.S. Cl. 428/407; 423/592; 423/608; 423/630; 423/263; 428/403

(57) ABSTRACT

Metal oxide microspheres, particularly zirconia microspheres, produced by a method of hydrolysis of metal alkoxides in alcohol solutions in the presence of an organic acid or salt thereof with washing step or addition of a surfactant.

This application claims the benefit of U.S. Provisional Application Serial No. 60/249,307, filed Nov. 16, 2000, U.S. Provisional Application Serial No. 60/248,189, filed Nov. 14, 2000, U.S. Provisional Application Serial No. 60/248,132, filed Nov. 13, 2000, and U.S. Provisional Application Serial No. 60/244,041, filed Oct. 28, 2000, all of which are incorporated herein by reference in their entirety.

### BACKGROUND

Recent advances in ultrafast chromatography have increased interest in the synthesis and use of monodisperse, substantially nonporous ceramic spheres preferably having a narrow microsphere size distribution of mean diameter between 1 and 3 micrometers (microns). To date the ceramic most commonly used has been silica (Unger et al., U.S. Pat. No. 4,775,520; Barder et al., U.S. Pat. No. 4,983,369; and Hanson et al., LC-GC, 15, 170-178 (1997)). The use of short chromatography columns (1 to 5 centimeters (cm)) packed with silica microspheres can significantly speed chromatographic analysis compared to standard, porous silica columns owing to faster interphase mass transfer kinetics (e.g., due to the absence of intramicrosphere pore diffusion). Several researchers have described applications for nonporous packings, including both native and modified silicas, mainly for the ultrafast chromatography of biopolymers.

It is generally known how to obtain unaggregated, nonporous, silica microspheres suitable for ultrafast chromatography. They can be made by the hydrolysis and condensation of alkoxysilanes to make nonporous particles directly or by depositing silica to fill the void volume within porous silica particles (Overbeek, Adv. Colloid Interf Sci., 15, 251-277 (1982); Unger et al., J. Chromatogr., 296, 3-14 (1984); van Helden et al., J. Colloid Interf. Sci., 81, 354-368 (1981); Stober et al., J. Colloid Interf. Sci., 26, 62-69 (1968); Unger et al., German Patent No. DE 3,534,143; and Colwell et al., J. Resolut. Chromatogr., 9, 304-305 (1986)).

Another ceramic, zirconia (ZrO₂), has recently been developed as a stationary phase support for liquid chromatography (Annen et al., J. Mater. Sci., 29, 6123-6130 (1994); Carr et al., U.S. Pat. No. 5,015,373; Rigney et al., J. Chromatogr., 484, 273-291 (1989); and Lorenzano Porras et al., J. Colloid Interf Sci., 164, 1-8 (1994)). Zirconia is chemically (pH=1-14) and thermally much more stable (>200° C.) than silica-based supports. The synthesis of porous zirconia spheres has been investigated (Iler et al., German Patent No. DE 2,317,454; Sun et al., J. Colloid Interf Sci., 163, 464-473 (1994); Stuart et al., Polym. J., 23, 669-682 (1991); Fleer et al., Croat. Chem. Acta., 60, 477-494 (1987); and Muhle, Colloid Polym. Sci., 263, 660-672 (1985)). However, there is still a need for metal oxide microspheres (particularly those that are substantially nonporous and monodisperse), such as zirconia microspheres, that can be used in applications such as ultrafast chromatography.

### SUMMARY OF THE INVENTION

The present invention provides a method of preparing metal oxide microspheres (i.e., spherical colloidal particles of micron dimension). The method includes: combining a metal alkoxide, water, and an organic acid or salt thereof in an organic solvent to form a reaction mixture; allowing microspheres to form in the reaction mixture (preferably this is done by agitating the reaction mixture to produce microspheres); removing the microspheres from the reaction mixture, wherein the microspheres have a reactive gel thereon; and washing the microspheres to remove at least a portion of (and preferably, substantially all) the reactive gel. The reactive gel includes partially hydrolyzed and condensed metal alkoxides and has been discovered to contribute to aggregation of the particles, which is undesirable for use in applications such as ultrafast liquid chromatography because it has been shown that particle aggregation decreases column efficiency. Thus, it is desirable to remove substantially all, or at least a portion of, this reactive gel. Alternatively, the reactive gel layer may be prevented from causing aggregation by the addition of a steric stabilizing agent such as hydroxypropylcellulose.

Preferably, after agitating the reaction mixture, the microspheres are allowed to age, typically with slow sample movement (e.g., fast enough to prevent settling but slow enough to avoid shear-induced flocculation). Significantly, and preferably, the as-produced microspheres (i.e., produced without classification) have a generally narrow particle size distribution. Preferably, a sample of microspheres having a desired average particle size (e.g., diameter) have a standard deviation of no more than about 30% of the mean, more preferably, no more than about 20% of the mean, and most preferably, no more than about 10% of the mean (i.e., they are substantially monodisperse). It is particularly important for chromatography applications to minimize the presence of particles that have a particle size that is more than one-half that of the average particle size. Preferably, a sample of microspheres are also substantially unaggregated. Preferably, the method further includes heating the washed microspheres to form substantially nonporous microspheres, preferably having a surface area that is within a factor of three of the theoretical surface area. As used herein, substantially nonporous microspheres do not allow a probe such as fluorescein isothiocyanate (a low MW fluorescent probe) within the interior of the microsphere.

In a particularly preferred embodiment, the present invention provides a method of preparing substantially nonporous, metal oxide microspheres. The method includes: combining a metal alkoxide, water, a C6-C30 carboxylic acid in an alcohol to form a reaction mixture; agitating the reaction mixture to produce microspheres; allowing the microspheres to age (preferably without stirring); removing the microspheres from the reaction mixture, wherein the microspheres have a reactive gel thereon; washing the microspheres to remove at least a portion of the reactive gel; and heating the washed microspberes under conditions and for a time to form substantially nonporous microspheres.

In another embodiment, the present invention provides a method of preparing metal oxide microspheres. The method includes: combining a metal alkoxide, water, an organic acid or salt thereof in an organic solvent to form a reaction mixture; allowing microspheres to form in the reaction mixture; adding a surfactant to the reaction mixture; and removing the microspheres from the reaction mixture.

The present invention also provides microspheres prepared by these methods.

In another embodiment, the present invention provides a sample of as-produced, substantially nonporous, metal oxide microspheres having an average particle diameter of about 0.1 micron to about 10 microns with a standard deviation of no more than about 30 percent of the mean. These substantially nonporous, metal oxide microspheres may be stationary phase material for chromatography and included in a chromatography device. For example, they may be packed in a length of tubing of a chromatographic column. The metal oxide may be selected from the group consisting of zirconia, titania, hafnia, alumina, niobia, yttria, magnesia, and mixtures thereof. The microspheres are preferably stable up to about pH 14 and up to at least about 150 degrees Celcius (° C.) in aqueous media. The microspheres may have a polymer coating thereon. The microspheres may be carbon-clad microspheres with the option of having a polymer coating thereon, such as, for instance, polybutadiene and polystyrene.

### BRIEF DESCRIPTION OF THE DRAWINGS

FIG. 1. SEM micrograph of microspheres synthesized by the “Lerot method” but using rigorously dried n-butanol. Synthesis conditions: [Zr(OPrⁿ)₄]=0.1 M, [H₂O]=0.42 M, [stearic acid]=0.016 M. Aging time=150 min. Induction time=37 min. Post synthetic treatment: centrifugation and butanol wash.

FIG. 2. SEM micrograph of microspheres synthesized by the “Lerot method” but using rigorously dried n-butanol. Synthesis conditions: [Zr(OPrⁿ)₄]=0.1 M, [H₂O]=0.42 M, [stearic acid]=0.016 M. Aging time=50 min. Induction time=33 min. Post synthetic treatment: centrifugation and isopropanol wash.

FIG. 3. SEM photograph of microspheres synthesized by the modified Lerot method. Synthesis conditions as in FIG. 1. Post synthetic treatment: dilution and filtration, heating schedule as described in text. (a) Using rigorously dried butanol. Induction time=35 min. Aging time=150 min. Particle size=1.68 microns. Yield=22%. (b) Using ACS grade butanol. Induction time=27 min. Aging time=150 min. Particle size=1.71 microns. Yield=26%. (c) Using ACS grade butanol. Induction time=12 min. Aging time=150 min. Particle size=1.73 microns. Yield=30%.

FIG. 4. The microsphere size distribution of the final nonporous zirconia microspheres of FIG. 3(a) (average size=1.68 microns, standard deviation=0.16).

FIG. 5. SEM photographs of final zirconia particles synthesized at different temperatures. Synthesis conditions: [Zr(OPrⁿ)₄]=0.1 M, [H₂O]=0.42 M, [stearic acid]=0.016 M, aging time=150 min., (a) Temperature=50° C., particle size=2.6 micron, standard deviation=0.17 micron; (b) Temperature=−5° C., particle size=0.9 micron and standard deviation=0.10 micron.

FIG. 6. SEM photograph of final zirconia particles synthesized at different water concentration. [Zr(OPrⁿ)₄]=0.1 M, [stearic acid]=0.016 M, aging time=30 min. (a) [H₂O]=0.42 M, particle size=1.24 microns, standard deviation=0.15 micron; (b) [H₂O]=0.45 M, particle size=1.12 microns, standard deviation=0.20 micron; (c) [H₂O]=0.48 M, particle size=0.84 micron, standard deviation=0.17 micron. Post synthetic treatment: dilution, filtration, washing, and heating schedule as described in Example I.

FIG. 7. SEM photograph of final zirconia particles synthesized using different organic acids. Synthesis conditions: [Zr(OPrⁿ)₄]=0.1 M, [H₂O]=0.42 M, (a) [decanoic acid]=0.016 M, particle size=1.14 microns, standard deviation=0.32 micron; (b) [eicosanoic acid]=0.016 M, particle size=2.7 microns and standard deviation=0.15 micron. Post synthetic treatment: dilution, filtration, washing, and heating schedule as described in Example III.

FIG. 8. SEM photograph of final titania particles synthesized by the modified Lerot method using n-butanol as described in Example IV. [Ti(OBuⁿ)₄]=0.1 M, [stearic acid]=0.016 M, [H₂O]=1.05 M, induction time=34 min, aging time=120 min.

FIG. 9. Chromatogram showing the separation of alkylbenzenes. Polystyrene coated nonporous zirconia microspheres. Solutes: (1) benzene, (2) toluene, (3) ethylbenzene, (4) propylbenzene, and (5) butylbenzene, and acetone. Column: PSCNPZ 100×4.6 mm id; Loading conditions (LC) Conditions: 0.5 ml/min, 25/75 ACN/water at 30° C., 254 nm detection, 2 μl injection of alkylbenzenes mix (2 mg/ml concentration).

FIG. 10. SEM photograph of particles synthesized by the modified Lerot method as generally described in Example I using ACS grade butanol and continuous stirring after the solution becomes cloudy. Synthesis conditions as in FIG. 1. Induction time=35 min. Aging time=150 min. Post synthetic treatment: dilution and filtration.

FIG. 11. Effect of water concentration on induction time. Synthesis carried out according to Example II with conditions as in FIG. 1, except the water concentration varies as indicated.

FIG. 12. Fraction of initial weight vs. temperature during microsphere drying and sintering (a) in drying oven at room temperature, (b) in a drying oven at 120° C. under vacuum, (c) in a combustion oven at 450° C., and (d) in a sintering oven at 750° C.

FIG. 13. SEM micrograph of the interior of the zirconia microsphere. Sections were made by dispersing microspheres in epoxy resin and polishing.

FIG. 14. Confocal fluorescence microscopy images of zirconia microspheres in a solution of FITC in 50 mM phosphate buffer (pH=7.0).

FIG. 15. SEM photograph of particles synthesized by the modified Lerot method as generally described in Example I using dry butanol. Synthesis conditions as in FIG. 1. Induction time=30 min. (a) Aging time=60 min. (b) Aging time=390 min. Post synthetic treatment: dilution and filtration.

FIG. 16. Plots of reduced plate height versus reduced velocity for PBDNPZ. The solid line is the nonlinear regression line fitted to the Knox equation. Mobile phase: 35/65 ACN/water, temperature=30° C. Solutes: (1) diamond denotes benzene, (2) square denotes toluene (3) triangle denotes ethylbenzene, (3) rectangle denotes propylbenzene, and (4) circle denotes butylbenzene.

FIG. 17. Charts showing the LSER study on (A) PBDNPZ and (B) PBD-coated porous zirconia using acetonitrile/water as mobile phases. Each column represents a coefficient of fit to the LSER equation logk′=logk′₀+mVₓ+sπ*₂+aΣα₂+bΣβ₂. The corresponding coefficients m, s, a, and b can be derived from regression analysis of the retention data.

FIG. 18. Charts showing the LSER study on (A) CNPZ and (B) carbon-coated porous zirconia using acetonitrile/water as mobile phases where mVₓ represents cavity formation and dispersion interactions, sπ*2 represents polar and dipolar interactions, aΣα₂ represents hydrogen bond basicity, and logk′₀ is the intercept term.

FIG. 19. Diagrams showing the thermal stability of (A) PSCNPZ and (B) CNPZ. Solutes: ● benzene, ◯ toluene, ▾ ethylbenzene, ∇ n-propylbenzene, ▪ n-butylbenzene.

FIG. 20. Diagrams showing (A) acid stability, flushing eluent: 35/65 acetonitrile/0.1 M HNO₃; (B) base stability, flushing eluent: 40/60 acetonitrile/1 M NaOH, chromatographic testing eluent: 35/65 acetonitrile/water; test solutes: ● benzene, ◯ toluene, ▾ ethylbenzene, ∇ n-propylbenzene, ▪ n-butylbenzene.

FIG. 21. Van't Hoff plots showing temperature effects on the selectivity of (A) alkylbenzenes on CNPZ and (B) PSCNPZ; test solutes: ● benzene, ◯ toluene, ▾ ethylbenzene, ∇ n-propylbenzene, ▪ n-butylbenzene.

FIG. 22. Diagrams showing the plot of logk′ vs the volume fraction of acetonitrile for CNPZ (A) and PBDNPZ (B); test solutes: ● benzene, ▾ ethylbenzene, ∇ n-propylbenzene, ▪ n-butylbenzene. S values: A: [symbol] s=3.1, ▾s=4.4, ∇s=5.1, ▪s=5.9; B: [symbol] s=2.8, ▾s=3.6, ∇s=4.2, ▪s=5.0.

FIG. 23. Chromatograms showing the separation of four EPA-priority phenols on PBDNPZ and porous 3 micron PBD coated zirconia. Column, PBDNPZ 50×4.6 mm id; Mobile phase, 25/75 ACN/water; Flow rate, 1 ml/min; Detector, 254 nm; Column Temperature=30° C.; Retention times of Solutes: (A): phenol (0.533 min), 4-chlorophenol (0.865 min), 4-chloro-3-methyl phenol (1.218 min), 2,4,6-trichlorophenol (3.427 min); (B): phenol (1.114 min), 4-chlorophenol (3.031 min), 4-chloro-3-methyl phenol (4.260 min), 2,4,6-trichlorophenol (approximately 10 min).

FIG. 24. Chromatogram showing the fast (40 seconds) separation of cosmetics on CNPZ at 150° C. using pure water as the mobile phase. Column, CNPZ 50×4.6 mm id; Mobile phase, 100% water; Flow rate, 1 ml/min; Detector, 254 nm; Column Temperature=150° C.; Solutes: impurity (0.404), allantoin (0.449 min), bronopol (0.600 min).

FIG. 25. Chromatograms showing the separation of seven trazines pesticides on PBDNPZ at ambient temperature and at 100° C. Column, PBDNPZ 50×4.6 mm id; Flow rate, 1 m/min; Detector, 254 nm; Column Temperature=30° C.; Solutes: mixture of 7 triazines pesticides; (A) Mobile phase, 5/95 ACN/water, 30° C., (B) 100% water, 100° C.

FIG. 26. Chromatogram showing ultrafast separation at high flow rate and at 150° C. on PSCNPZ. Column, CNPZ 50×4.6 mm id; Mobile phase, 20/80 ACN/water; Flow rate, 4 ml/min; Detector, 254 nm; Column Temperature=150° C.; Solutes: benzene (0.296 min), toluene (0.343 min), ethylbenzene (0.408 min), propylbenzene (0.533 min), butylbenzene (0.750 min).

FIG. 27. Chromatogram showing monoclonal antibody separation on EDTPA-NPZ. Column Dimension, 50×4.6; Mobile phase, 100% A stepped to 100% B at 10 minutes, returning to 100% A at 18 minutes, where A is 4 mM N,N,N′,N′-ethylenediaminetetra-methylenephosphonic acid (EDTPA), 20 mM MES, 50 mM NaCl, pH 4.0, and B is 4 mM EDTPA, 20 mM 2-(N-Morpholino)-ethanesulfonic acid (MES), 2.0 M NaCl, pH 4.0; Temperature, 30° C.; Detection at 280 nm; Flow Rate at 0.5 ml/min; Injection volume, 50 ml; Antibody=Ms×human pulmonary and activation-regulated chemokine (hPARC), clone #64509.11 from R&D Systems; Sample concentration=1 mg/ml, Immunoglobulin G (IGG) (13.5 min).

FIG. 28. Chromatogram showing isomer separation. Column, PBDNPZ 50×4.6 mm id; Mobile phase, 20/80 ACN/water; Flow rate, 1 ml/min; Detector, 254 nm; Column Temperature=30° C.; Solutes: o-xylene (5.009 min), m-xylene and p-xylene (5.648 min).

### DETAILED DESCRIPTION OF PREFERRED EMBODIMENTS

The present invention provides metal oxide microspheres (e.g., zirconia, titania, hafnia, alumina, niobia, yttria, or magnesia microspheres, or mixed oxides thereof, etc.), preferably zirconia spheres, that are preferably monodisperse and substantially unaggregated. Preferably, the microspheres as-produced (i.e., without classification) have an average diameter of about 0.1 micron to about 10 microns with a standard deviation of no more than about 30% (more preferably, no more than about 20%, and most preferably, no more than about 10%) of the mean. Thus, the microspheres of the present invention as-produced are preferably substantially monodisperse and substantially unaggregated.

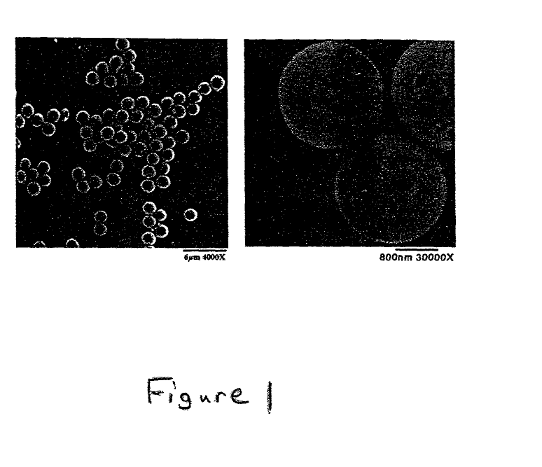

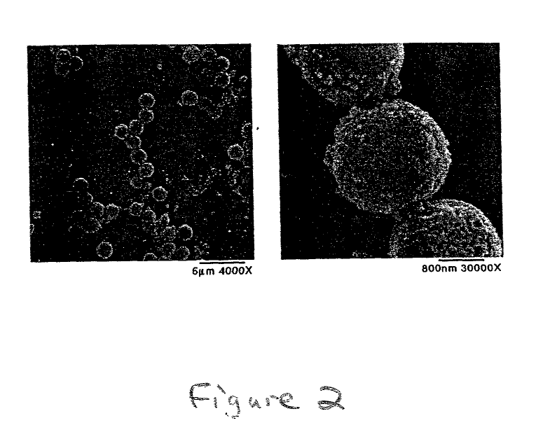

The method of obtaining such microspheres involves the hydrolysis of alcohol solutions of metal alkoxides in the presence of fatty acids as described in Lerot et al., J. Mater. Sci., 26, 2353-2358 (1991) and is referred to herein as the “Lerot method.” This approach has two principle advantages compared to other related approaches. The hydrolysis of aqueous solutions of zirconium salts, e.g., ZrOCl₂, can be used to prepare zirconia particles, but these particles are apparently much smaller, as shown in FIG. 1, than the size needed for ultrafast chromatography and they are not generally spherical as evidenced by the formation of “necks” between microspheres (FIG. 2). Also, zirconia microspheres can be prepared using seeds (rather than a fatty acid), and one could attempt to sinter and fill the pores of monodisperse porous zirconia, but such procedures are not as straightforward as that of the present invention.

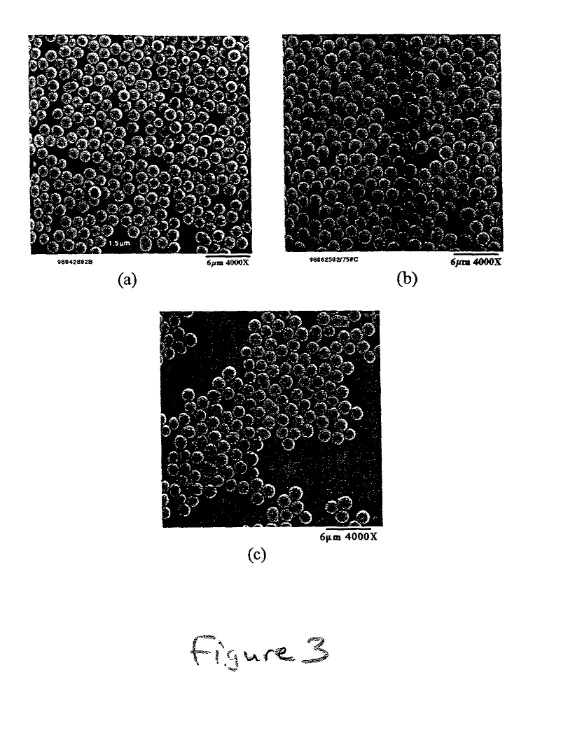

Unfortunately, using the method described in Lerot et al., J. Mater. Sci., 26, 2353-2358 (1991), does not reproducibly produce unaggregated microspheres suitable for ultrafast liquid chromatography. The main difficulty encountered is microsphere aggregation. The present invention eliminates, or at least substantially reduces, the problem of particle aggregation as shown in FIG. 3. Although not intending to be limited by theory, it is believed that aggregation results from the presence of a reactive gel on the microspheres. This reactive gel includes partially hydrolyzed and polymerized metal alkoxides.

Significantly and preferably, the method of the present invention is generally reproducible if residual water in the reagents (particularly, the solvent) is avoided, and the relationship between mixing and nucleation timing are monitored. That is, to ensure reproducibility, the following steps are preferably taken: 1) cease agitation at a reproducible time prior to aging the microspheres; and 2) use reagents dry enough (or of reproducible, known water content) to maintain good control of the particle appearance time.

Preferably, the methods of the present invention involve combining a metal alkoxide, water, and an organic acid or salt thereof (e.g., carboxylic acid, sulfonic acid, phosphonic acid, and salts thereof) in an organic solvent (e.g., an alcohol) to form a reaction mixture allowing the microspheres to form in the reaction mixture (preferably, agitating the reaction mixture to produce microspheres), removing the microspheres from the reaction mixture (preferably, by filtering), wherein the microspheres have a reactive gel thereon, and washing the microspheres to remove at least a portion of (and preferably substantially all) the reactive gel.

Examples of metal alkoxides include normal and branched butoxides, propoxides, ethoxides, and methoxides of zirconium, titanium, aluminum, silicon, niobium, etc., and mixtures thereof. Preferably, the organic acid or salt thereof is linear or branched, saturated or unsaturated, and preferably a C6-C30 carboxylic acid, such as stearic, dodecanoic, icosenoic, palmitic, or lauric acid, or mixtures thereof. If a carboxylic acid is used, it has been discovered that the particle size can be controlled by the chain length of the carboxylic acid; the longer the chain, the larger the particle size. The solvent is preferably an alcohol (more preferably, an anhydrous alcohol such as butanol, propanol, or ethanol) or other organic solvent (or mixtures of solvents) that is miscible with the other components.

The synthesis typically begins with the treatment of a solution of the metal alkoxide with the organic acid or salt in an “exchange” step. Next, the mixing step typically occurs over a period of about 0.5 minute to about 5 minutes (preferably, 1 minute to 3 minutes) and involves homogenization of the precursors into a generally clear solution at the overall composition desired. Preferably, the mixing step is carried out at a temperature that provides a single phase solution (preferably, room temperature (i.e., 20-30° C.)). The water reagent is preferably withheld until homogenization is complete and then water is added to begin an “induction” step.

The reaction mixture is then allowed to form microspheres (typically by agitating the reaction mixture until microspheres are formed). The formation of microspheres is typically evidenced by the formation of cloudiness, which is referred to herein as the “induction” period. Agitation can be carried out by stirring, shaking, ultrasonics, flow, convection, etc. Preferably, the agitation is sufficiently vigorous such that the composition is uniform during the induction period. The agitation step can be continued for up to about 50 minutes (preferably, for only up to about 5 minutes) after the reaction mixture becomes cloudy, although longer time periods can be used if larger particles are desired. For significant reproducibility of particle size from batch to batch, the time period of agitation is rigidly controlled from batch to batch. That is, the induction time will be reproducible so long as the exchange time is long enough and agitation during the induction time is intense enough. The extended agitation period, though, is preferably rigidly controlled. Typically, the temperature at which agitation is carried out is one that maintains a single phase. Preferably, it is room temperature.

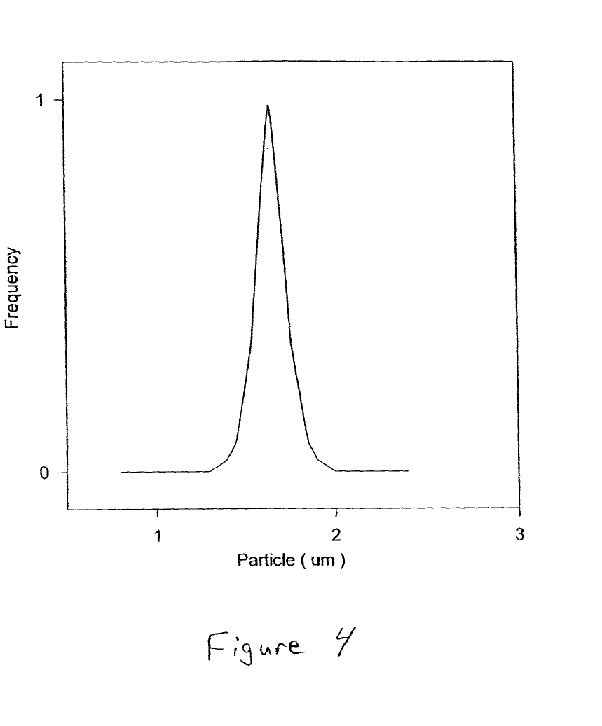

After agitating the reaction mixture, the microspheres are allowed to age, preferably with generally slow sample movement (e.g., rocking, rolling, rotating) if necessary to avoid settling. Typically, at the end of the induction period, the particles are smaller than desired and generally not monodisperse. Thus, aging is carried out for a sufficient period of time to establish growth and for the particles to become monodisperse. The particles will become substantially monodisperse as long as the aging period after agitation is long enough to restore monodispersity. FIG. 4 shows for a particularly preferred embodiment that 90% of the microspheres are between 1.5 microns and 1.9 microns.

Aging also allows the yield to increase. Typically, microspheres are aged for a time sufficient to provide a desired yield of a desired particle size. This can be in as few as 2 minutes. Generally, there is no limit to the amount of time the microspheres can be allowed to age. Preferably, aging is carried out for at least about 150 minutes for particles having a particle size of about 1.7 microns. The slow sample movement (e.g., rotation) is preferred to prevent sample settling. If too much settling of the microspheres occurs, there is danger of nonuniform reaction and preparation of polydisperse particle sizes. After aging, the reaction is quenched, typically using anhydrous alcohol or any organic solvent that is miscible and does not flocculate the suspension. This aging process is typically carried out at room temperature, although any temperature can be used as long as the suspension is not frozen or boiled. Higher temperature will typically accelerate the process.

After the aging process, the microspheres typically have a reactive gel thereon. The reactive gel includes partially hydrolyzed and polymerized metal alkoxides. It can be removed through washing with anhydrous alcohol and acetone or any organic solvent or combination of solvents that will dissolve the reactive layer. The washing can be done at any temperature that allows solubilization of this reactive gel. The washing is typically done shortly after removing the microspheres from the reaction mixture, although it can be done after an extended period of time as long as it is done before heating the microspheres to remove organics.

Alternatively, the reactive layer can be left in place and the particles prevented from irreversibly aggregating by protecting them with an absorbing polymeric additive such as hydroxypropylcellulose or other ionic or nonionic surfactant. This is typically added before collection of the particles and used in a sufficient amount (e.g., 0.1 gram per liter in 100 grams per liter of mixture) to form a monolayer and prevent significant aggregation upon or after collection.

Removing the microspheres from the reaction mixture typically involves filtering or centrifuging, taking measures to avoid a significant amount of irreversible aggregation by removal of the reactive layer, or protection with hydroxypropylcellulose. Although some aggregation is allowable, a very small amount (e.g., less than about 10%) of the microspheres are aggregated. Filtration is the preferred method of collection; however, centrifuging can be used if the microspheres are washed sufficiently to remove the reactive gel shortly after centrifuging. In this way aggregation of the spheres is avoided or at least significantly reduced compared to when the reactive gel is present. Preferably, the reaction mixture is diluted by preferably at least a factor of two in order to substantially arrest further reaction during the filtering or centrifuging time. Dilution typically occurs by the addition of preferably the same solvent or mixture of solvents used during previous steps.

The microspheres produced at this stage of the process are soft and porous. They could be incorporated into composite materials such as elastomer/ceramic composites (tires, etc.).

The present invention preferably provides microspheres using a post-synthetic heating schedule that ensures that they become substantially nonporous (as determined by nitrogen sorptometry and by confocal fluorescence microscopy) while avoiding the formation of strongly sintered aggregates. Preferably, they are heated in stages. Generally, this staged heating schedule involves a ramped temperature profile for drying the microspheres, driving off the volatile organic materials from the microspheres, removing nonvolatile organic materials from the microspheres, and sintering them to form substantially nonporous particles. For example, the microspheres are initially heated at a temperature and for a time to remove substantially all the volatile organic material (preferably, at a temperature of about 100° C. to about 350° C., and more preferably, at a temperature of about 100° C. to about 200° C.). This heating step preferably is carried out in a vacuum to accelerate removal of volatile organics, although this is not required.

The microspheres are then typically heated in air or in sufficient oxygen at a higher temperature and for a time to remove substantially all the nonvolatile organic material (preferably, at a temperature of about 200° C. to about 1100° C., and more preferably, at a temperature of about 200° C. to about 500° C.). Subsequently, they are heated at a temperature and for a time to densify the microspheres (preferably, at a temperature of about 400° C. to about 1100° C., and more preferably, at a temperature of about 600° C. to about 1100° C.) to form substantially nonporous microspheres.

Preferably, the resultant densified microspheres are at their theoretical density and have a surface area that is within a factor of three of the theoretical surface area (to allow for expected surface roughness). For example, the theoretical surface area of a 1.65 micron zirconia particle, which has a 5.8 g/ml density, is about 0.63 m²/g. Surface texture of the microspheres can readily account for the difference between actual and theoretical. The microspheres produced at this stage of the process (i.e., without any coatings thereon) can be used as catalyst supports or for ion exchange and normal phase chromatography, for example.

The resultant microspheres can be coated with carbon and/or organic polymer coatings using methods known in the art. Carbon-coated microspheres provide a very effective reversed-phase liquid chromatographic stationary phase material that can be used for environmental, pharmaceutical, and biological analyses. They can be used at very high temperatures, thereby reducing eluent viscocities and allowing high flow rates to be used. Carbon-coated microspheres of zirconia are stable from pH 1 to 14 and at column temperatures up to about 200° C. The microspheres of the present invention can be coated with organic polymers, such as polybutadiene, either in place of or in addition to the carbon coating.

Various coatings and methods of coating carbon and polymers are known in the art. For example, coatings on inorganic oxide particles and methods of coating such particles are disclosed in U.S. Pat. Nos. 5,015,373, 5,108,597, 5,254,262, 5,271,833, and 5,346,619, as well as EP 0 331 283 B1.

In one particular coating method, the microspheres of the present invention can be clad or coated with a layer of pyrolytic carbon using a chemical vapor deposition process. The terms “pyrolytic carbon” and “CVD carbon” are generic terms relating to the carbon material that is deposited on the substrate by the thermal pyrolysis of a carbon-bearing vapor. The term “CVD carbon” describes the processing used, whereas the term “pyrolytic carbon” refers more to the type of carbon material that is deposited. While any method of applying pyrolytic carbon to a substrate can be used in the preparation of the present carbon-clad microspheres, it is preferable to apply the carbon cladding in a manner which results in substantial carbon coverage of the surface of the microspheres.

Chemical vapor deposition (CVD) is a vapor phase process wherein a solid material is formed on a substrate by the thermal dissociation or the chemical reaction of one or more gas species. The deposited solid material can be a metal, semiconductor, alloy, or refractory compound. This topic is discussed in more detail in 9 The Chemistry and Physics of Carbon, 173-263 (P. Walker et al., eds. 1973), the disclosure of which is incorporated by reference herein.

Any carbon source that can be vaporized and which will carbonize on the surface of the microspheres can be employed to deposit a carbon cladding via CVD. Useful carbon sources include hydrocarbons such as aromatic hydrocarbons, e.g., benzene, toluene, xylene, and the like; aliphatic hydrocarbons, e.g., heptane, cyclohexane, substituted cyclohexane butane, propane, methane, and the like; unsaturated hydrocarbons; branched hydrocarbons (both saturated and unsaturated), e.g., isooctane; ethers; ketones; aldehydes; alcohols such as heptanol, butanol, propanol, and the like; chlorinated hydrocarbons, e.g., methylene chloride, chloroform, trichloroethylene, and the like; and mixtures thereof. The carbon source may be either a liquid or a vapor at room temperature and atmospheric pressure although it is employed in a CVD process in vapor form. If the carbon source is a liquid with low volatility at room temperature, it may be heated to produce sufficient vapor for the deposition. In general, the choice of the deposition temperature, pressure, and time conditions are dependent on the carbon source employed and the nature of the metal oxide.

Preferably, the methods of depositing a thin film or clad of carbon over the as-produced microspheres involve placing the microspheres into a reaction chamber and elevating the temperature within the reaction chamber to about 500° C. to about 1500° C. A vapor comprising carbon is introduced into the chamber so as to decompose the vapor and deposit a cladding of carbon onto the microspheres. The microspheres are typically coated for about 300 to about 400 minutes, which should substantially cover the surface of the microspheres. The reaction chamber is typically then quickly cooled to about 120° C. to about 50° C. After cooling, the carbon-clad microspheres are removed from the reaction chamber and typically washed with an aromatic hydrocarbon (e.g., toluene), a 1:1 alcohol:aromatic hydrocarbon (e.g., ethanol:toluene), and/or an aliphatic hydrocarbon (e.g., hexane). The microspheres are then typically dried in a vacuum oven at about 90° C. to about 130° C. for about 10 to about 14 hours.

Preferably, the thickness of the carbon cladding over the surface of the metal oxide core ranges from the diameter of a single carbon atom (a monatomic layer), to about 20 Angstroms (Å). This carbon cladding will thus not appreciably increase the diameter of the microspheres.

A wide variety of cross-linkable organic materials, which may be monomers, oligomers or polymers, can be employed to coat the microspheres of the present invention with or without the carbon coating. For example, such materials include polybutadiene, polystyrene, polyacrylates, polyvinylpyrrolidone (PVP), polyvinyl alcohol (PVA), polyorganosiloxanes, polyethylene, poly(C1-C4)alkylstyrene, polyisoprene, polyethyleneimine, and polyaspartic acid. Any of the common free radical sources including organic peroxides such as dicumyl peroxide, benzoyl peroxide or diazo compounds such as 2,2′-azobisisobutyronitrile (AIBN) may be employed as cross-linking agents in the practice of the present invention. Useful commercially available peroxyesters include the alkylesters of peroxycarboxylic acids, the alkylesters of monoperoxydicarboxylic acids, the dialkylesters of diperoxydicarboxylic acids, the alkylesters of monoperoxycarbonic acids and the alkylene diesters of peroxycarboxylic acids. These peroxyesters include t-butyl peroctoate, t-butyl perbenzoate, t-butyl peroxyneodecanoate and t-butyl peroxymaleic acid. Oligomers may also be polymerized by irradiation with UV light or gamma rays or by exposure to high energy electrons.

The chemical character (Reversed Phase, Ion Exchange, etc.) of microspheres or carbon-clad microspheres of the present invention can be controlled by coating the particles with a selected pre-polymer such as, for instance, polybutadiene and polystyrene. The polymeric coating is generally performed in two steps. First, a pre-polymer is deposited on the surface of the microsphere or carbon-clad microsphere. Second, the pre-polymer is immobilized by a cross-linking reaction, thereby creating a continuous polymeric coating on the surface of the microsphere. The pre-polymer can be deposited on the microsphere surface in a variety of ways, including pre-polymer deposition by solvent removal, selective adsorption from solution, and gas phase deposition.

Preferably, the methods of depositing a polymeric coating over the microspheres or carbon-clad microspheres of the present invention involve placing dry nonporous microspheres in an oven at about 110° C. to about 140° C. for about 18 to about 30 hours, thereafter removing the microspheres and allowing them to cool. A cross-linkable organic material, e.g., polybutadiene, is then combined with the microspheres in a suitable solvent and mixed to suspend the microspheres in solution. Once the microspheres are well suspended they are contacted with a free radical source.

When chemical cross-linking agents are used, the cross-linking reaction is preferably carried out under vacuum, to inhibit oxidation of the pre-polymer or polymer. Alternatively, the cross-linking reaction can be carried out in an inert gas, such as nitrogen or helium. After cooling under a vacuum and rinsing with solvent to remove residual pre-polymer, the resultant polymer-coated particles can be packed into HPLC columns by dry packing or upward slurry packing, depending on their particle size.

After their preparation according to the present method, the microspheres of the present invention may be packed into a chromatography column, particularly a liquid chromatography column, such as for ultrafast liquid chromatography (LC), as well as reversed-phase chromatography, ion-exchange chromatography, hydrophobic interaction chromatography, etc. to perform liquid chromatographic separations. Conventional slurry packing techniques can be employed to pack LC columns with the spherules. For a general discussion of LC techniques and apparatuses, see Remington's Pharmaceutical Sciences, A. Osol, ed., Mack Publishing Col, Easton, Pa. (16th ed. 1980), at pages 575-576.

### EXAMPLES

Objects and advantages of this invention are further illustrated by the following examples, but the particular materials and amounts thereof recited in these examples, as well as other conditions and details, should not be construed to unduly limit this invention.

I. Experiments to Optimize Conditions for Making Monodisperse, Substantially Nonporous zirconia microspheres.

(1) Materials

Reagent grade zirconium propoxide (Zr(OPrⁿ)₄, 70 percent (%) weight per weight (w/w) solution in normal propanol) was purchased from Aldrich. After a given bottle of zirconium propoxide was first opened, it was stored in a desiccator with phosphorous pentoxide as the desiccant. Reagent grade (ACS grade) and technical n-butanol were purchased from Fisher Scientific Co. HPLC grade isopropanol was purchased from Pharmca. For the experiments described herein (unless otherwise noted), the butanol was rigorously dried by heating with magnesium ribbons (Herold et al., Z. Phys. Chem., 12B, 94-205 (1931)) and then redistilled. Stearic acid (greater than 95%) and acetone (analytical grade) were purchased from Aldrich. Distilled water was deionized just prior to use.

Scanning electron microscopy (SEM) using a JEOL 8401 instrument (approximately 100-Angstrom resolution) characterized the microsphere size, shape, and state of aggregation. To verify that there were no visible pores in the internal structure, the microspheres were dispersed in epoxy resin (118778, Cole-Parmer, Chicago, Ill.), polished to expose the interior of some microspheres, sputter-coated with a 50-Angstrom layer of platinum and then viewed in the instrument.

Another method used to show that the microspheres are substantially nonporous was confocal fluorescence microscopy. Images were obtained using a Bio-Rad MRC-600 confocal microscope powered by an argon-ion laser with a 488 nm high excitation blue filter. Fluorescein isothiocyanate (FLTC) was used to image the void spaces around (and in principle within) microsphere. The samples were prepared for confocal microscopy according to the method described by Reeder, “Pore Structure and Mass Transport within Colloidal Aggregates for Liquid Chromatography,” Ph.D. Thesis, University of Minnesota, pages A1-A9, 1997.

Nitrogen sorptometry was performed on a 10 gram sample of the microspheres using a Micromeritics ASAP 2000 sorptometer. Such a large sample is required to ensure accurate surface area determination of a low surface area material.

A convenient, alternative method to assess porosity is to measure the amount of fluoride which is adsorbed on the surface relative to the amount of fluoride adsorption of a material with similar surface chemistry but known specific surface area. Before fluoride adsorption measurements, the microspheres were treated to remove any impurities and to fully rehydrate the surface. One to three grams of porous zirconia of known specific surface area were weighed into 200 milliliter (ml) bottles, 120 ml of 0.5 molar (M) hydrochloric acid were added, and the suspension was sonicated for 20 minutes. The suspensions were allowed to digest overnight. To remove the acid solution, the microspheres were washed three times with water and three times with acetone, and finally they were dried under vacuum at 120° C. The surface area of chemically similar samples is proportional to the fluoride adsorption capacity using a fluoride sensitive electrode (Orion Research Digital Ionalyzer/501). A solution of 0.1 M TAPS (N-tris[hydroxymethyl]-3-aminopropane sulfonic acid, from SIGMA Chemical Co.) and 20 millimolar (mM) sodium fluoride were used. A 50 ml portion of 0.1 M TAPS buffer (pH=8.4) was added to each container. The solutions were sonicated for 10 minutes to fully wet the nicrospheres, and a dilution solution containing about 0.006 moles of sodium fluoride solution was added, with sonication and ten minutes allowed between aliquots. The amount of fluoride remaining in solution was indicated by the fluoride electrode. The same experiment, when performed with a known mass of the synthesized nonporous microspheres, should indicate the surface area.

(2) Preparation of Monodisperse Zirconia Microspheres

The following procedure, adapted from Lerot, describes a typical, optimized preparation at an overall reactor composition of 0.1 M zirconium propoxide, 0.42 M water, and 0.016 M stearic acid in n-butanol. A small amount of n-propanol was also present from the zirconium propoxide precursor solution and is generated by the hydrolysis of the zirconium propoxide, but the maximum possible resulting ratio of n-propanol to n-butanol is only 0.05.

A 0.96 gram (g) portion of stearic acid was weighed into a 250 ml polyethylene wide-mouth bottle, 100 ml of anhydrous butanol were added, and the bottle was tightly closed. The solution was stirred for 30 minutes (min) to allow full dissolution. Then 11.7 ml of the zirconium propoxide solution was slowly added with stirring, and the mixture was stirred for an additional 30 min; this is referred to as the “exchange” time, alluding to reaction between the zirconium propoxide, the fatty acid, and butanol. A longer exchange time makes no further difference, but exchange times much shorter than 30 min can cause significant differences from the results shown below.

A fresh solution of 87 ml of anhydrous butanol and 1.51 ml of deionized water (0.42 M) were then slowly added with stirring to the zirconium-containing solution over a period of 1 min. The bottle was tightly closed and the mixture was vigorously stirred by a magnetic stirrer. This was continued for a time termed the “induction time,” at which time the solution became cloudy. In the present case, the induction time was 35 min.

At the induction time, stirring was stopped and the suspension was allowed to age without agitation (150 min), but with gentle rolling to prevent settling. The reaction was then quenched by gently mixing with the reactor contents 200 ml of anhydrous butanol. The suspension was then vacuum-filtered through a previously used 60 M glass sintered Buchner funnel. The microspheres were washed three times by gently resuspending them in 50 ml of anhydrous butanol and refiltering. The microspheres were finally washed with three 50-ml aliquots of acetone. This filtering and washing procedure allowed the collection of the still soft (gel-like) and reactive microspheres without significant agglomeration or intergrowth.

After washing, the microspheres were subjected to a heating schedule that avoids rupture of the microspheres, ensures uniform rates throughout the sample, allows particles to densify to become substantially nonporous, and avoids sintering the microspheres to one another. The following procedure was found satisfactory for microspheres prepared over a range of synthesis variables. The microspheres were transferred to a crucible by a spatula and were dried in a vacuum oven at 120° C. for three hours. The crucible was then transferred to a combustion oven, the temperature was ramped at 5° C./min to 450° C., and the microspheres were kept at 450° C. for three hours to burn off any organic matter. Then the temperature was raised to 750° C. at 5° C./min and then held at 750° C. for five hours to remove substantially all residual organic matter and to allow densification. Finally, the temperature was decreased at 5° C./min to room temperature.

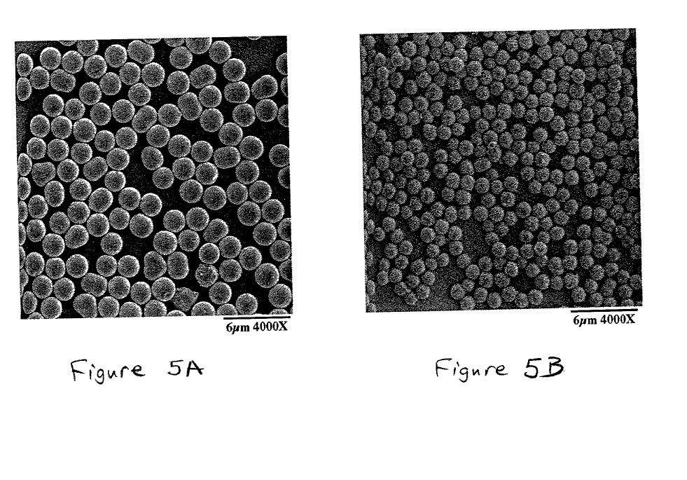

The effect of temperature on the particle size was investigated. FIG. 5 clearly shows that temperature has a dramatic affect on particle growth. Over a temperature range of −5° C. to 50° C. with all other parameters held constant, the particle size increases from 0.9 micron to 2.6 microns. Decreasing the temperature in the aging period slows down the hydrolysis rate, resulting in slower particle growth. Thus temperature is another convenient and effective parameter for controlling particle size.

Using this procedure, from batch to batch the average microsphere was reproducibly 1.7 microns in diameter (which is in the optimum range for ultrafast HPLC), and the zirconium atom yield (fraction from the propoxide precursor in the final microspheres) was between 18% and 26%.

II. Experiments Using Different Water Concentrations for Making Monodisperse, Substantially Nonporous Zirconia Microspheres.

(1) Materials

Reagent grade zirconium propoxide (Zr(OPrⁿ)₄, 70% (w/w) solution in n-propanol was purchased from Aldrich. After a given bottle of zirconium propoxide was first opened, it was stored in a desiccator with phosphorous pentoxide as the desiccant. Reagent grade (ACS grade) n-butanol was purchased from Fisher Scientific Co. Stearic acid (greater than 95%) and acetone (analytical grade) were purchased from Aldrich. Distilled water was deionized just prior to use.

Scanning electron microscopy (SEM) using a JEOL 8401 instrument (approximately 100-Angstrom resolution) characterized the microsphere size, shape, and state of aggregation. To verify that there were no visible pores in the internal structure, the microspheres were dispersed in epoxy resin (#8778, Cole-Parmer, Chicago, Ill.), polished to expose the interior of some microspheres, sputter-coated with a 50-Angstrom layer of platinum and then viewed in the instrument.

(2) Preparation of Monodisperse Zirconia Microspheres

A 0.96 g portion of stearic acid was weighed into a 250 ml polyethylene wide-mouth bottle, 100 ml of anhydrous butanol was added, and the bottle was tightly closed. The solution was stirred for 30 min to allow full dissolution. Then 11.7 ml of the zirconium propoxide solution was slowly added with stirring, and the mixture was stirred for an additional 30 min.

A fresh solution of 87 ml of anhydrous butanol and 1.51 ml (0.42 M) deionized water was then slowly added with stirring to the zirconium-containing solution over a period of 1 min. Note that the amounts of water were 1.62 ml (0.45 M) and 1.81 ml (0.48 M) when the water concentration effect was studied. The bottle was tightly closed and the mixture was vigorously stirred by a magnetic stirrer. This was continued for a time termed the “induction time,” at which time the solution became cloudy. In this case, the induction times are 26 min for [H₂O]=0.42 M, 14 min for [H₂O]=0.42 M, 7 min for [H₂O]=0.48 M.

At the induction time, stirring was stopped and the suspension was allowed to age without agitation or gentle rolling; in this experiment, the aging time was kept at 30 min. The reaction was then quenched by gently mixing with the reactor contents 200 ml of anhydrous butanol. The suspension was then vacuum-filtered through a previously used 60 M glass sintered Buchner funnel. The microspheres were washed three times by gently resuspending them in 50 ml of anhydrous butanol and refiltering. The microspheres were finally washed with three 50 ml aliquots of acetone. This filtering and washing procedure allowed the collection of the still soft (gel-like) and reactive microspheres without significant sticking or intergrowth.

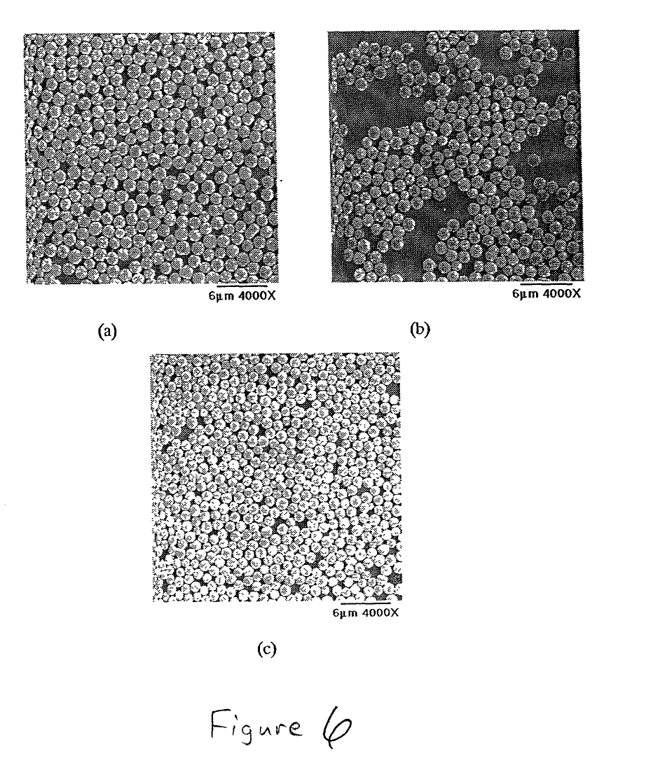

After washing, the microspheres were subjected to the following heating schedule. The microspheres were transferred to a crucible by a spatula and were dried in a vacuum oven at 120° C. for three hours. The crucible was then transferred to a combustion oven, the temperature was ramped at 5° C./min to 450° C., and the microspheres were kept at 450° C. for three hours. Then the temperature was raised to 750° C. at 5° C./min and then held at 750° C. for five hours. Finally, the temperature was decreased at 5° C./min to room temperature. The SEMs of FIG. 6 show that monodisperse zirconia microspheres with different sizes were made by different water concentrations.

III. Experinments Using Decanoic Acid and Eicosanoic Acid for Making Monodisperse, Substantially Nonporous Zirconia Microspheres.

(1) Materials

Reagent grade zirconium propoxide (Zr(OPrⁿ)₄, 70% (w/w) solution in n-propanol was purchased from Aldrich. After a given bottle of zirconium propoxide was first opened, it was stored in a desiccator with phosphorous pentoxide as the desiccant. Reagent grade (ACS grade) n-butanol was purchased from Fisher Scientific Co. Decanoic acid (99%), eicosanoic acid (99%), and acetone (analytical grade) were purchased from Aldrich. Distilled water was deionized just prior to use.

Scanning electron microscopy (SEM) using a JEOL 8401 instrument (approximately 100-Angstrom resolution) characterized the microsphere size, shape, and state of aggregation. To verify that there were no visible pores in the internal structure, the microspheres were dispersed in epoxy resin (#8778, Cole-Parmer, Chicago, Ill.), polished to expose the interior of some microspheres, sputter-coated with a 50-Angstrom layer of platinum and then viewed in the instrument.

(2) Preparation of Monodisperse Zirconia Microspheres

A 0.55 g portion of decanoic acid (or 1.00 g eicosanoic acid) was weighed into a 250 ml polyethylene wide-mouth bottle, 100 ml of anhydrous butanol were added, and the bottle was tightly closed. The solution was stirred for 30 min to allow full dissolution. Then 11.7 ml of the zirconium propoxide solution were slowly added with stirring, and the mixture was stirred for an additional 30 min.

A fresh solution of 87 ml of anhydrous butanol and 1.51 ml (0.42 M) deionized water were then slowly added with stirring to the zirconium-containing solution over a period of 1 min. The bottle was tightly closed and the mixture was vigorously stirred by a magnetic stirrer until the solution became cloudy. In this case, the induction times were 28 min for decanoic acid and 18 min for eicosanoic acid.

At the induction time, stirring was stopped and the suspension was allowed to age without agitation or gentle rolling; in this experiment, the aging time was kept at 150 min. The reaction was then quenched by gently mixing with the reactor contents 200 ml of anhydrous butanol. The suspension was then vacuum-filtered through a previously used 60 M glass sintered Buchner funnel. The microspheres were washed three times by gently resuspending them in 50 ml of anhydrous butanol and refiltering. The microspheres were finally washed with three 50 ml aliquots of acetone. This filtering and washing procedure allowed the collection of the still soft (gel-like) and reactive microspheres without significant sticking or intergrowth.

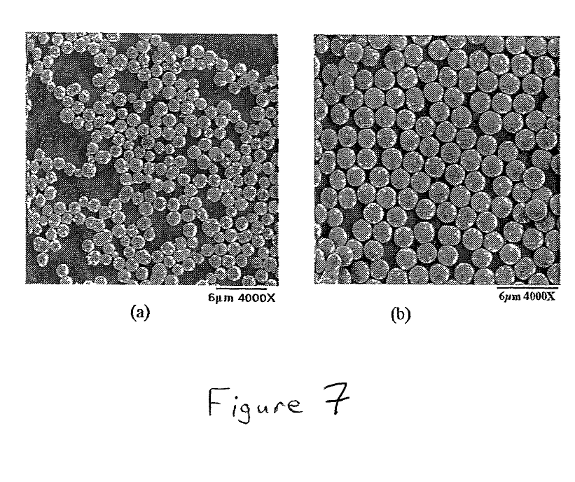

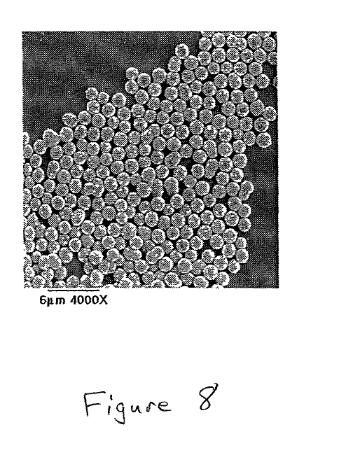

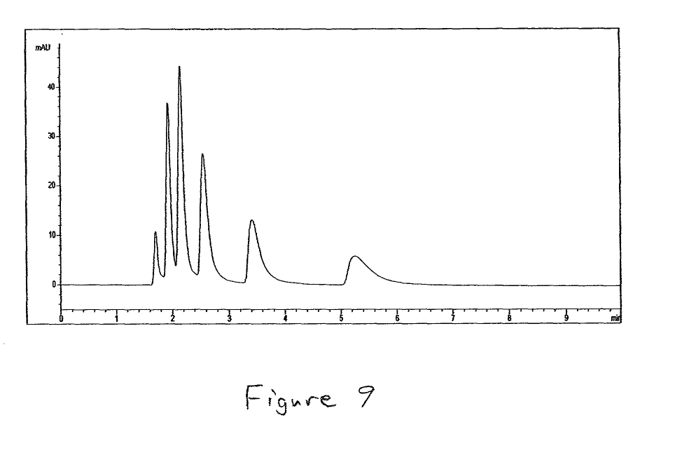

After washing, the microspheres were subjected to the following heating schedule. The microspheres were transferred to a crucible by a spatula and were dried in a vacuum oven at 120° C. for three hours. The crucible was then transferred to a combustion oven, the temperature was ramped at 5° C./min to 450° C., and the microspheres were kept at 450° C. for three hours. Then the temperature was raised to 750° C. at 5° C./min and then held at 750° C. for five hours. Finally, the temperature was decreased at 5° C./min to room temperature. The SEMs of FIG. 7 show that monodisperse zirconia microspheres with different sizes were made by different carboxyl acids.

IV. Experiments for Making Monodisperse, Substantially Nonporous Titania Microspheres.

(1) Materials

Reagent grade titanium butoxide (Ti(OBuⁿ)₄) was purchased from Aldrich. After a given bottle of titanium butoxide was first opened, it was stored in a desiccator with phosphorous pentoxide as the desiccant. Reagent grade (ACS grade) n-butanol was purchased from Fisher Scientific Co. Stearic acid (greater than 95%) and acetone (analytical grade) were purchased from Aldrich. Distilled water was deionized just prior to use.

Scanning electron microscopy (SEM) using a JEOL 8401 instrument (approximately 100-Angstrom resolution) characterized the microsphere size, shape, and state of aggregation. To verify that there were no visible pores in the internal structure, the microspheres were dispersed in epoxy resin (#8778, Cole-Parmer, Chicago, Ill.), polished to expose the interior of some microspheres, sputter-coated with a 50-Angstrom layer of platinum and then viewed in the instrument.

(2) Preparation of Monodisperse Tifania Microspheres

A 0.96 g portion of stearic acid was weighed into a 250 ml polyethylene wide-mouth bottle, 100 ml of anhydrous butanol were added, and the bottle was tightly closed. The solution was stirred for 30 min to allow full dissolution. Then 7.0 g of the titanium butoxide solution were slowly added with stirring, and the mixture was stirred for an additional 30 min.

A fresh solution of 87 ml of anhydrous butanol and 3.78 ml (1.05 M) deionized water were then slowly added with stirring to the titanium-containing solution over a period of 1 min. The bottle was tightly closed and the mixture was vigorously stirred by a magnetic stirrer. This was continued for a time termed the “induction time,” at which time the solution became cloudy. In this case, the induction time was 34 min.

At the induction time, stirring was stopped and the suspension was allowed to age without agitation or gentle rolling; in this experiment, the aging time was kept at 120 min. The reaction was then quenched by gently mixing with the reactor contents 200 ml of anhydrous butanol. The suspension was then vacuum-filtered through a previously used 60 M glass sintered Buehner funnel. The microspheres were washed three times by gently resuspending them in 50 ml of anhydrous butanol and refiltering. The microspheres were finally washed with three 50 ml aliquots of acetone. This filtering and washing procedure allowed the collection of the still soft (gel-like) and reactive microspheres without significant sticking or intergrowth.

After washing, the microspheres were subjected to the following heating schedule. The microspheres were transferred to a crucible by a spatula and were dried in a vacuum oven at 120° C. for three hours. The crucible was then transferred to a combustion oven, the temperature was ramped at 5° C./min to 400° C., and the microspheres were kept at 400° C. for three hours. Then the temperature was raised to 500° C. at 5° C./min and then held at 500° C. for five hours. Finally, the temperature was decreased at 5° C./min to room temperature. The SEM shown in FIG. 8 shows the monodisperse titania microspheres made by this method.

V. Preparation of Polymer Coated Nonporous Zirconia Microspheres

(1) Carbon Coated Nonporous Zirconia Microspheres

A thin film or cladding of carbon was deposited over the zirconia substrate of “bare” or unclad ZrO₂ microspheres using the following process.

Fifteen grams of nonporous zirconia was loaded into a rotating quartz tube. An organic bubbler was filled. The entire deposition system was then flushed at ambient temperature by the following 4-step method: (1) nitrogen was flowed through the ball meter to the organic solvent and to the auxiliary flow and through the bubbler at 10 cubic centimeters per minute (cc/min) for 10 min; (2) the vent of the bubbler was opened for a few seconds to remove trapped air from the system; (3) nitrogen was run through a bubbler bypass for 5 minutes; and (4) the ball meter to the organic solvent was shut off and nitrogen was run through the auxiliary flow meter for 5 min. The traps were then filled with ice and water. The furnace temperature was raised to 700° C., maintaining nitrogen flow through the system. The quartz tube was then set to rotate at a rate of 1 revolution per minute (first mark on rotator control). The heated zirconia was equilibrated for 1 hour, maintaining nitrogen flow through the system at 10 cc/min and ensuring all the zirconia remained in the heated zone of the tube. The organic solvent level was then marked, the ball meter to the organic solvent was opened to organic vapor, and the auxiliary flow from the second ball meter was shut off. The zirconia was coated for exactly 360 minutes. After the coating was completed, the auxiliary flow to the second ball meter was opened and flow to the organic solvent system was closed. The furnace was then cooled to 100° C. as quickly as possible by opening the furnace top, maintaining nitrogen flow. After the furnace was cooled, the nitrogen flow was completely shut off. Uncoated particles and residual material on the tube surface were removed by wiping the ends of the tube using a long teflon rod and a Kimwipe sprayed with ethanol. The coated particles were then removed and placed into an extraction thimble. To the extraction thimble was added 100 ml of toluene, with stirring to wet the particles. The particles were extracted using a Soxhlet extractor with toluene for 12 hours. The particles were then filtered and collected on a sintered glass funnel and washed with 200 ml toluene, 150 ml of 1:1 ethanol:toluene, and 250 ml hexane. Air was pulled through the cake until it flowed freely, then the particles were dried in a vacuum oven at 110° C. for approximately 12 hours.

(2) Polybutadiene Coated Nonporous Zirconia Microspheres

Nonporous zirconia was coated with polybutadiene using the following process.

Twenty grams of nonporous zirconia was dried at 125° C. in a clean oven for 24 hours. The zirconia was then allowed to cool in a dessicator. A 50 ml Erlenmeyer flask was charged with 0.9 grams polybutadiene (PBD) and the volume was brought up to 15 ml by adding HPLC grade hexane. Four ml of the PBD solution was poured into a 500 ml baffled round bottom flask. The cooled zirconia was added to the flask. The flask containing the PBD solution and zirconia was then sonicated under vacuum for 10 min, placed on a rotary station, and swirled for 2 hours to ensure the particles were well suspended in the solution. In a separate flask, 270 miligrams of dicumylperoxide (DCP) was combined with 100 ml of hexane. The DCP solution was sonicated and placed under vacuum for a few minutes. One hundred microliters (μl) of the DCP solution was diluted up to 25 ml using hexane, and the diluted DCP solution was placed in the 500 ml baffled round bottom flask containing the PBD solution and zirconia, and the flask was placed on a rotary station and swirled at room temperature for 2 hours. The solvent was then evaporated off using a rotary evaporator set at 55° C. and a vacuum of 14 inches Hg for 30 minutes. The particles were transferred to a crucible and placed in a clean vacuum oven. The oven was prepared by first flushing it with ultra pure grade 5 nitrogen at a flow rate of 10 cc/minute for 1 hour, then pulling a vacuum of approximately 25 inches Hg and closing the valves. After the vacuum was achieved, the particles were dried in the oven at 110° C. for 1 hour, the temperature was raised to 160° C., and the crosslinking reaction was carried out at 160° C. for 5 hours. The oven was then turned off and the particles were allowed to cool under vacuum. The particles were then transferred from the crucible to a Soxhlet extractor and extracted using 500 ml of toluene for 12 hours. The particles were then collected on a sintered glass funnel and rinsed with 400 ml of ethanol. Air was pulled through the cake for 3 hours until the particles were dry. The particles were then placed in a collection container in a refrigerator.

(3) Polystyrene Coated Nonporous Zirconia Microspheres

Nonporous zirconia was coated with polystyrene using the following process.

A 500 ml round flask was charged with 2000 μl chloromethylstyrene (0.2 ml CMS/g NPZ), 400 μl diethoxymethylvinylsilane (40 μl DMVS/g NPZ), 60 mg dicumyl peroxide (6 mg DCP/g NPZ), and 150 ml HPLC grade toluene. A stirbar and several small teflon boiling chips were added to the flask. A reflux condenser was attached to the flask and the flask and condenser assembly was placed in a heating mantle on top of a stir plate. The polymer mixture was refluxed for 4 hours with stirring. The flask was then allowed to cool to the touch. In a clean 1000 ml round bottom flask, 20 grams of nonporous zirconia was combined with 250 ml of toluene. The mixture was sonicated under vacuum for 10 minutes with swirling. The cooled polymer was then added to the 1000 ml flask containing the zirconia and toluene, first removing the stirbar and boiling chips. The polymer flask was then rinsed with two aliquots of 50 ml of toluene and the toluene rinses were added to the 1000 ml flask. A reflux condenser was then attached to the flask and the flask and condenser assembly was placed in a heating mantle. The mixture was refluxed for 3 hours. The mixture was allowed to cool, then was filtered on a 0.45 micron membrane filter. The particles were rinsed with two aliquots of 50 ml of toluene heated to a temperature of approximately 80° C. The particles were dried under vacuum for 10 minutes, then transferred to a crucible, placed in a vacuum oven, and dried under vacuum for 1 hour at 80° C. After 1 hour, the oven temperature was raised to 160° C. and the crosslinking reaction was carried out for 5 hours. The particles were then removed from the oven and extracted using a Sohlet extractor with toluene for 12 hours. Following extraction, the particles were washed with 200 ml of toluene, 150 ml of 1:1 ethanol:toluene, and 250 ml hexane. The particles were then dried under vacuum at room temperature for 2 hours, transferred to a crucible and then dried for 6 hours at 110° C.

(4) Polybutadiene on Carbon Clad Nonporous Zirconia Microspheres

(a) Carbon Coating

Nonporous zirconia is first coated with carbon using the procedure of Example V(1), above.

(b) Polybutadiene Coating on Top of the Carbon Clad Zirconia:

Twenty grams of the carbon coated nonporous zirconia were dried at 125° C. in a clean oven for 24 hours then cooled in a dessicator. A 50 ml Erlenmeyer flask was charged with 0.67 grams of polybutadiene (PBD) and the volume was brought up to 50 ml by adding HPLC grade hexane. Thirteen ml of the PBD solution was diluted to 50 ml with hexane, and the diluted PBD solution was added to a baffled round bottom flask. The cooled coated zirconia was added to the flask containing the diluted PBD solution and the flask was sonicated and swirled as was carried out in Example V(2), above. In a separate flask, 160 mg of dicumylperoxide (DCP) was combined with 100 ml of hexane. The solution was sonicated and placed under vacuum for a few minutes. Thirteen ml of the DCP solution was diluted to 25 ml with hexane. The diluted DCP solution was added to the baffled round bottom flask containing the zirconia and diluted PBD solution, the flask was placed on a rotary station, and the contents of the flask swirled at room temperature for 2 hours. The solvent was evaporated, and the resulting particles were dried, crosslinked, extracted by Soxhlet extractor, rinsed, and dried following the procedure of Example V(2), above.

VI. Chromatographic Examples of Nonporous Zirconia-Based HPLC Supports

(1) Column Packing

Packing conditions for all the below nonporous zirconia-based HPLC columns are as follows:

Column Dimensions:

length: 10 cm.

diameter: 4.6 mm.

Slurry:

Solvent: Tetrahydrofuran (THF) 18 ml

Mass in Bomb: 5 g.

Sonication Time: 30 min.

Packing Bomb Volume: 20 cc.

Time from Sonication to Pressurization: 50 seconds

Bomb Pre-fill Volume: 0 ml

Reservoir Solvent:

Solvent: THF

Degas Time: 0 min

Packing:

Packing Pressure: 7000 psi

Inlet Gas Pressure: 53 psi

Total packing time: 30 min.

(2) Chromatographic Nature of Carbon Coated Nonporous Zirconia Microsphere Packed HPLC Column

A chromatographic study was performed on the carbon coated nonporous zirconia microspheres using a 100×4.66 mm HPLC column (column CZ032000) with a carbon load of 0.80% packed with carbon coated nonporous zirconia microspheres as the stationary phase. A 42/58 volume/volume (%v/%v) acetonitrile/water solution at 30° C. at a rate of 0.8 milliliter per minute (ml/min) was used as the mobile phase.

A 2 μl sample of a mixture (2 milligram per milliliter (mg/ml)) of alkylbenzenes (benzene, toluene, ethylbenzene, propylbenzene, and butylbenzene) and acetone was injected onto the packed HPLC column. Properties of the carbon coated nonporous zirconia microsphere packed column were calculated for each solute, including, for instance, capacity factor (i.e., the ratio of solute concentration in the stationary phase to solute concentration in the mobile phase) which was calculated for each solute by evaluating the ratio (tᵣ−tₒ)/tₒ, where tᵣ is retention time measured at peak maximum, and tₒ is column dead time measured by solvent mismatch. The results are listed in Table 1 below.

TABLE 1

| | | | Peak | Peak | | | Tailing | |
|---|---|---|---|---|---|---|---|---|
| Solute | Time | k′ | Area | Height | Width | Symmetry | Factor | Plates |
| Acetone | 1.553 | 0 | 42.4 | 7.5 | 0.08 | 0.46 | 2.2 | 2698 |
| Benzene | 1.953 | 0.257566 | 5.1 | 9.5 | 0.099 | 0.42 | 2.4 | 1958 |
| Toluene | 2.492 | 0.604636 | 104.6 | 8.8 | 0.167 | 0.38 | 2.6 | 948 |
| Ethylbenzen | 2.824 | 0.818416 | 109.4 | 8.3 | 0.192 | 0.34 | 2.9 | 1346 |
| Propylbenze | 4.123 | 1.654862 | 55.3 | 2.8 | 0.269 | 0.36 | 2.8 | 946 |
| Butylbenzen | 6.707 | 3.318738 | 39.2 | 1.1 | 0.596 | 0.25 | 4 | 907 |

The results shown in Table 1 indicate that the carbon coated nonporous zirconia microspheres show typical reversed-phase chromatographic behavior. As the molecule gets larger and more hydrophobic, retention increases on the phase.

(3) Chromatographic Nature of Polybutadiene Coated Nonporous Zirconia Microsphere Packed HPLC Column

A chromatographic study was also performed on polybutadiene coated nonporous zirconia microspheres using a 100×4.66 mm HPLC column (column S/N PBDNPZ) with a carbon load of 0.88% packed with the polybutadiene coated nonporous zirconia microspheres as the stationary phase. A 42/58 (%v/%v) acetonitrile/water solution at 30° C. at a rate of 0.5 ml/min was used as the mobile phase.

A 2 μl sample of a mixture (2 mg/ml) of alkylbenzenes (benzene, toluene, ethylbenzene, propylbenzene, and butylbenzene) and acetone was injected onto the packed HPLC column. Retention results of the alkylbenzene sample on the polybutadiene coated nonporous zirconia microsphere packed column are shown below in Table 2.

TABLE 2

| Solute | TR | k′ | Area | Height | Width | Symmetry | Tailing | Plates |
|---|---|---|---|---|---|---|---|---|
| Acetone | 1.606 | 0 | 24.1 | 6.4 | 0.058 | 0.55 | 1.82 | 4457 |
| Benzene | 2.608 | 0.62391 | 84.7 | 18.1 | 0.071 | 0.69 | 1.45 | 8403 |
| Toluene | 3.224 | 1.007472 | 119.4 | 22.9 | 0.079 | 0.72 | 1.39 | 10175 |
| Ethylbenzene | 4.151 | 1.584682 | 92 | 14.2 | 0.099 | 0.77 | 1.30 | 10657 |
| Propylbenzene | 5.82 | 2.62391 | 72.7 | 7.5 | 0.147 | 0.9 | 1.11 | 9259 |
| Butylbenzene | 8.687 | 4.409091 | 58.3 | 3.8 | 0.229 | 1.1 | 0.91 | 8388 |

The results shown in Table 2 indicate that the polybutadiene coated nonporous zirconia microspheres show typical reversed-phase chromatographic behavior and good column efficiency. As the molecular gets larger and more hydrophobic, retention increases on the phase.

(4) Chromatographic Nature of Polystyrene Coated Nonporous Zirconia Microsphere Packed HPLC Column

A chromatographic study was additionally performed on polystyrene coated nonporous zirconia microspheres using a 100×4.66 mm HPLC column packed, as described above, with the polystyrene coated nonporous zirconia microspheres as the stationary phase. A 25/75 (%v/%v) acetonitrile/water solution at 30° C. was used as the mobile phase.

A 2 μl sample of a mixture of alkylbenzenes was injected onto the packed HPLC column. The resulting chromatogram is shown in FIG. 9.

(5) Chromatographic Nature of Polybutadiene Coated Carbon Clad Zirconia Nonporous Zirconia Microsphere Packed HPLC Column

A chromatographic study of polybutadiene coated carbon clad nonporous zirconia microspheres was performed using a 100×4.66 mm HPLC column (column S/N PBDNPZ) with a carbon load of 1.08% packed with the polybutadiene coated carbon clad nonporous zirconia microspheres as the stationary phase. A 42/58 (%v/%v) acetonitrile/water solution at 30° C. at a rate of 0.5 ml/min was used as the mobile phase.

A 2 μl sample of a mixture (2 mg/ml) of alkylbenzenes (benzene, toluene, ethylbenzene, propylbenzene, and butylbenzene) and acetone was injected onto the packed HPLC column. Retention results of the alkylbenzene sample on the polybutadiene coated carbon clad nonporous zirconia microsphere packed column are shown in Table 3 below.

TABLE 3

| | | | | | | | Tailing | |
|---|---|---|---|---|---|---|---|---|
| Solute | TR | k′ | Area | Height | Width | Symmetry | Factor | Plates |
| Acetone | 1.613 | 0 | 49.8 | 14.3 | 0.053 | 0.72 | 1.39 | 5547 |
| Benzene | 2.199 | 0.363298 | 207.9 | 36.8 | 0.083 | 0.48 | 2.08 | 4735 |
| Toluene | 2.8 | 0.735896 | 283.8 | 31.1 | 0.13 | 0.35 | 2.86 | 3202 |
| Ethylbenzene | 3.442 | 1.133912 | 224.6 | 23.8 | 0.137 | 0.42 | 2.38 | 4043 |
| Propylbenzene | 5.041 | 2.125232 | 169.2 | 11.2 | 0.218 | 0.35 | 2.86 | 3309 |
| Butylbenzene | 8.065 | 4 | 120 | 5 | 0.35 | 0.36 | 2.78 | 2832 |

The results shown in Table 3 indicate that the polybutadiene coated carbon clad zirconia nonporous zirconia microsphere show typical reversed-phase chromatographic behavior. As the molecule gets larger and more hydrophobic, retention increases on the phase.

### Results and Discussion

Zirconia microspheres synthesized in the manner reported in Lerot et al., Journal of Materials Science, 26, 2353-2358 (1991) (“Lerot method”) were monodisperse and spherical, but they aggregated extensively. Notably, it appears that using this method failed to quench the reaction before collecting. Also, particle collection was accomplished by centrifugation, followed by an isopropanol wash, and a heating procedure. There is evidence in the micrographs of the formation of “necks” between microspheres, as shown in FIG. 2. It is probable that such necks form during the centrifugation, since at that stage the microspheres are still soft, reactive, and sticky. Indeed, it was impossible to completely redisperse the microspheres after centrifugation. During centrifugation, the compressive stress on the microspheres can no doubt easily overcome the repulsive barrier that ordinarily prevents microsphere aggregation, and the reactant concentration is high enough to cause intergrowth before collection. Reducing the centrifugation velocity did not eliminate this problem, and it worsened the yield and polydispersity because the reaction continues in the centrifuge tube. The concentration of zirconium propoxide in the butanol is still high at that stage, so it is very easy to cause particle aggregation during centrifugation. There are “necks” between microspheres and there are also numerous fine microspheres (less than 0.1 micron), as shown in FIG. 1. However, addition of hydroxypropyl cellulose before fast centrifugation can alleviate this problem.

FIG. 3(a) shows an entirely representative batch of microspheres as synthesized by the method of the present invention with butanol and acetone wash. The microspheres are clearly monodiperse and spherical, with no evidence of aggregation or necking. The microsphere size distribution in FIG. 4 shows that 90% of the microspheres are between 1.5 microns and 1.9 microns. The mean diameter is 1.68 microns and the standard deviation is only 0.21 micron. Note that the surface of the microspheres in FIG. 3(a) appears rougher than that of FIGS. 1 and 2. It is believed that the washing step removed a layer of reactive gel, thereby reducing aggregation and intergrowth during collection. Butanol washing alone, however, did not remove the reactive gel, and the spheres stuck together as shown in FIG. 1.

A significant modification to Lerot's method lies in the collection procedure, which preferably includes now prescribes dilution of the suspension (to quench the reaction) followed by filtration to speed separation and avoid large compressive forces, followed by washing with butanol and acetone to remove the reactive gel layer and allow redispersion. The still-wet washed microspheres can be fully redispersed (with sonication).

Two more subtle, but important, changes were made to provide reproducible and predictable behavior. First, it is important to use butanol (or other solvent) that is dry enough (or of controlled moisture content) to avoid affecting the induction time and varying the microsphere size, yield, and size distribution. To further explore the sensitivity of this process to moisture, freshly opened ACS reagent grade butanol (less than 0.03% (w/w) water in butanol) was used. Using freshly opened ACS grade solvent, the induction time was at worst about 4 min shorter than with the rigorously dried butanol. However, FIG. 3(b) shows that the microspheres produced are very similar. The mean diameter was 1.71 microns and the standard deviation 0.24 micron. Using technical grade butanol (note that there is no specification on water concentration), the induction time was reduced to only 12 min. FIG. 3(c) shows that the microspheres remain monodisperse and spherical. The mean diameter was 1.73 microns and the standard deviation 0.26 micron.

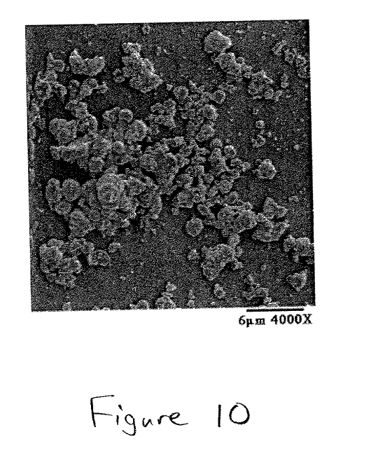

Second, to avoid shear-induced flocculation and microsphere breakage, it is important to stop agitation as soon as the solution becomes cloudy (or soon thereafter). FIG. 10 shows the deterioration of particle size distribution when stirring was continued long after the mixture became cloudy. The particles were neither monodisperse nor spherical. There was also evidence both of shear-induced flocculation and of particle breakage due to shearing. In sum, it is very important to stop or reduce stirring after the solution becomes cloudy. Finally, it is important that the reactor composition allow adequate mixing during the induction time. Up to this point, the ultimate reactor water concentration was held at 0.42 M in order to obtain a reasonable yield in a reasonable time while ensuring that the induction time was long enough to ensure adequate mixing. FIG. 11 shows that this water/zirconium ratio (4.2/1) represents a balance between two competing goals. If a higher water/zirconium ratio is used, the reaction is faster and higher yields can be attained at the target microsphere size, but the induction time can become so short that reagent mixing becomes difficult to achieve before colloid appearance. In such situations, significant polydispersity and batch-to-batch irreproducibility were obtained unless special measures were taken to improve mixing. On the other hand, if the water to zirconium ratio is too low, the induction time (here represented just in the induction time) becomes inconveniently slow and the yield and microsphere size become very small unless reaction times are significantly extended.

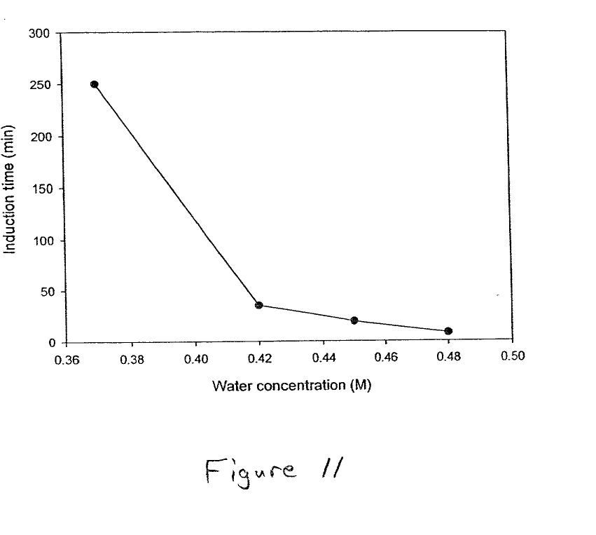

The heating schedule presented allows volatile components to be removed and for the particles to be densified without deterioration of the particle size distribution or generation of pores. FIG. 12 shows the weight loss at different temperatures. The first step in the heating schedule was to dry the microspheres under vacuum at 120° C. This mild heating allowed the volatile organics in the microsphere to be removed. The microspheres at 120° C. were still yellow and remained about 30% larger than their ultimate diameter, and still contained a large amount of nonvolatile organic matter. Next the microspheres were heated in air. In order to prevent microsphere breakage due to overly fast combustion of this nonvolatile organic material, the temperature of the combustion oven was slowly raised to only 450° C. The largest weight decrease took place during this combustion stage. After this stage, the microspheres were light grey and were only slightly larger than the final size. To densify the largely inorganic microspheres and to remove any remaining organic material, the oven was finally raised to 750° C. There was only a minor weight loss at this stage. The resultant microspheres were virtually fully dense (see below) and white.

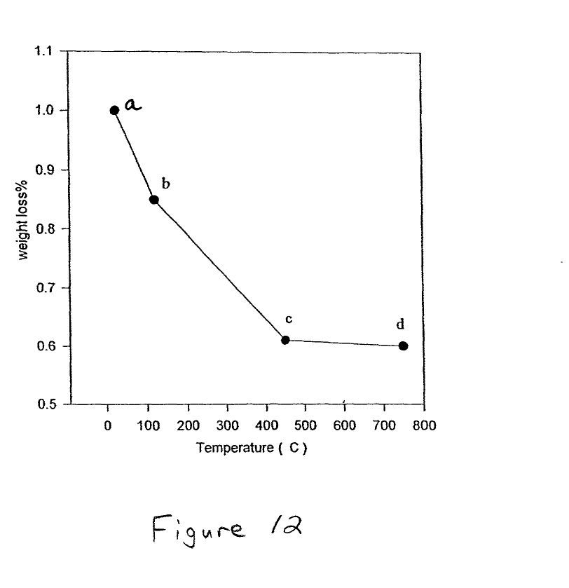

In order to confirm that the microspheres were substantially nonporous, micrographs were recorded of microspheres held in an epoxy resin and polished to expose the interior; an example is shown in FIG. 13. Aside from some debris, such surfaces of microspheres showed no features at 100-Angstrom resolution. There were no large channels or pores such as are visible in porous zirconia chromatography stationary phase. Although the surface in FIG. 13 is rough, it appears that the interior was of nearly uniform density. This suggests that, although a layer of reactive material was washed away from the surface in the washing step, reactive material remained inside the particle to form almost uniform density zirconia. The roughness of the micrographs suggested a variation in defect density. This is consistent with the theory that the growth of such a microsphere may be surface reaction (nucleation) limited.

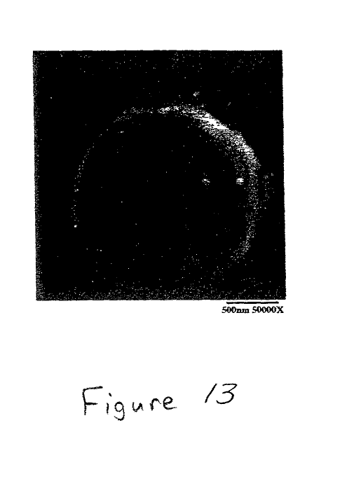

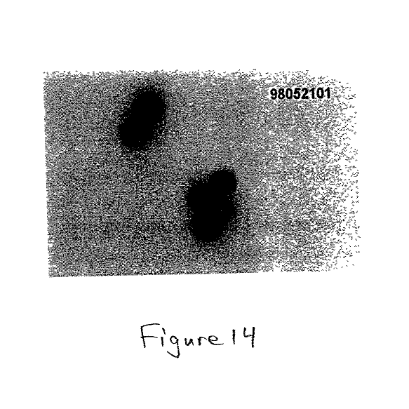

To further verify that the microspheres were substantially nonporous, they were examined by confocal fluorescence microscopy (CFM). FIG. 14 shows a CFM image after attempting to penetrate the microsphere with fluorescein isothiocyanate (a low MW fluorescent probe). The dark centers show that the probe did not access the microsphere interior, indicating the absence of pores larger than the probe in the microsphere.

Of course, pores smaller than approximately 10 Angstroms might still be there. About 10 g of material is needed to perform accurate BET nitrogen adsorption measurement of the surface area. This gives a density of 0.7 square meters per gram (m/² g), quite close to the theoretical surface area of dense zirconia spheres of 1.7 microns, which is 0.6 m²/g. On a more routine basis with small samples, the fluoride adsorption capacity (Blackwell, “Metal Ion Modified Zirconium Oxide Based Chromatographic Supports,” Ph.D. Thesis, University of Minnesota, pages 143-218 (1991)) of the microspheres was used to determine the surface area relative to a sample of known surface area (from BET). The fluoride adsorption capacity of zirconia microspheres was consistent for several batches showing that the surface area is reproducible as shown in Table 4. For polymerization induced colloidal aggregation ZrO₂ (PICA-ZrO₂), which is a method for producing zirconia particles as disclosed in U.S. Pat. No. 5,540,834, issued Jul. 30, 1996, entitled “Synthesis of porous inorganic particles by polymerization-induced colloid aggregation (PICA),” the surface area is 30 m²/g, the pore diameter is 287 Å, and the fluoride capacity of PICA-ZrO₄ is 2.4 micromoles per meter squared (μmol/m²).

TABLE 4

| | Surface area |
|---|---|
| Batch No. | μmol/m² |
| 1 | 7.2 |
| 2 | 6.9 |
| 3 | 7.1 |
| 4 | 7.3 |
| 5 | 7.2 |
| Average | 7.1 |
| Standard | 0.2 |
| Deviation | |

In the course of these experiments, it was found that the fluoride adsorption capacity is three times higher than for porous zirconia described in Blackwell, Ph.D. thesis perhaps suggesting significantly different crystal size, morphology and perhaps even phase (e.g., tetragonal vs. monoclinic) difference. FIG. 15 shows that different particle sizes can be made using this procedure by changing aging time.

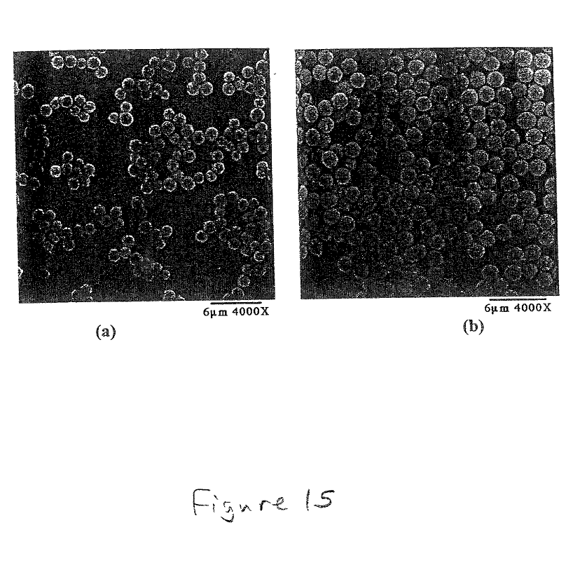

In order to investigate the relationship between the column efficiency and mobile phase velocity, reduced plate heights and reduced flow velocity for a homolog series of alkylbenzes (FIG. 16) were fit to the well known Knox equation:

h=Av^{⅓}+B/v+Cv (1)

where A, B, and C are related to packing quality, longitudinal diffusion, and mass transfer resistance in the stationary phase, respectively. The A coefficients were between 3-5 in all cases, and the B coefficients had values between 1.2-1.8. The C coefficients ranged from 0.04 to 0.06, indicating very good mass transfer within the stationary phase.

In the Linear Solvation Energy Relationship (LSER) study the retention of a wide variety of chemically distinct probe solutes were examined over a range in mobile phase composition of 20/80-45/55 (v/v) acetonitrile/water and 30/70-50/50 methanol/water mobile phases. Retention factor data was fit to the following LSER equation, where retention is modeled as a linear combination of four terms and an intercept term:

logk′=logk′₀+mVₓ+sπ*₂+aΣα₂+b Σ₂ (2)

where mVₓ represents cavity formation and dispersion interactions, sπ*₂ represents polar and dipolar interactions, aΣα₂ represents hydrogen bond acidity, bΣβ₂ represents hydrogen bond basicity, and logk′₀ is the intercept term. The corresponding coefficients m, s, a, b can be derived from regression analysis of the retention data. The contribution to retention due to cavity formation in the stationary phase, dispersion interactions, polar/polarizability, and hydrogen bond acidity and basicity in reference to the mobile phase composition was investigated. The relative importance of each type of chemical interaction in relation to retention of solutes was quantified.

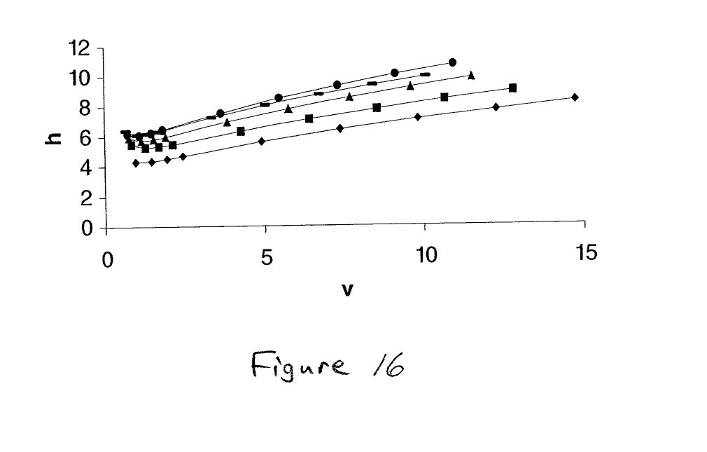

The regression results are shown in FIG. 17 for polybutadiene-coated nonporous zirconia (PBDNPZ). In general, the LSER regressions gave high correlation coefficients for all the mobile phase compositions studied. The average residuals are in the range of 0.09-0.12 and the correlation coefficients are all better than 0.99. These results agree well with the results obtained by Li et al., J. Chromatogr. 334, 239 (1996), who studied PBD coated on porous zirconia. A minor difference between PBDNPZ and PBD coated-porous zirconia is in the a coefficient, which is more negative in PBDNPZ, indicating that hydrogen bond basicity of a solute on PBDNPZ contributes less to retention than on porous PBD coated zirconia.

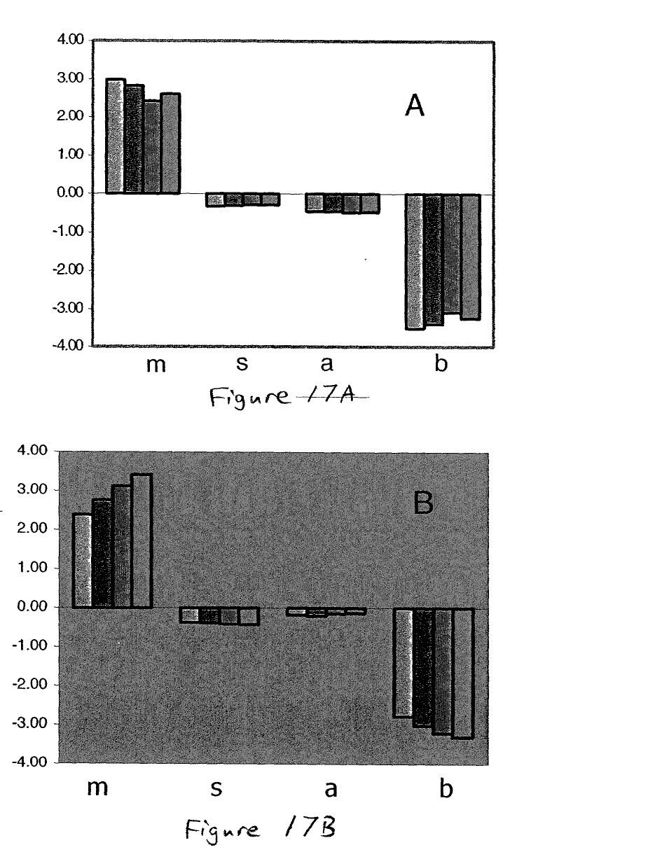

FIG. 18 shows the LSER comparison between carbon-coated nonporous zirconia (CNPZ) and carbon coated porous zirconia. These results agree well with Jackson et al., Anal. Chem., 69(3):416-425 (1997) (FIG. 18B); both studies resulted in large positive s-term, which is stark contrast to PBD coated zirconia. Thus analyses will have more retention on carbon due to increased π-π interactions with stationary phase.

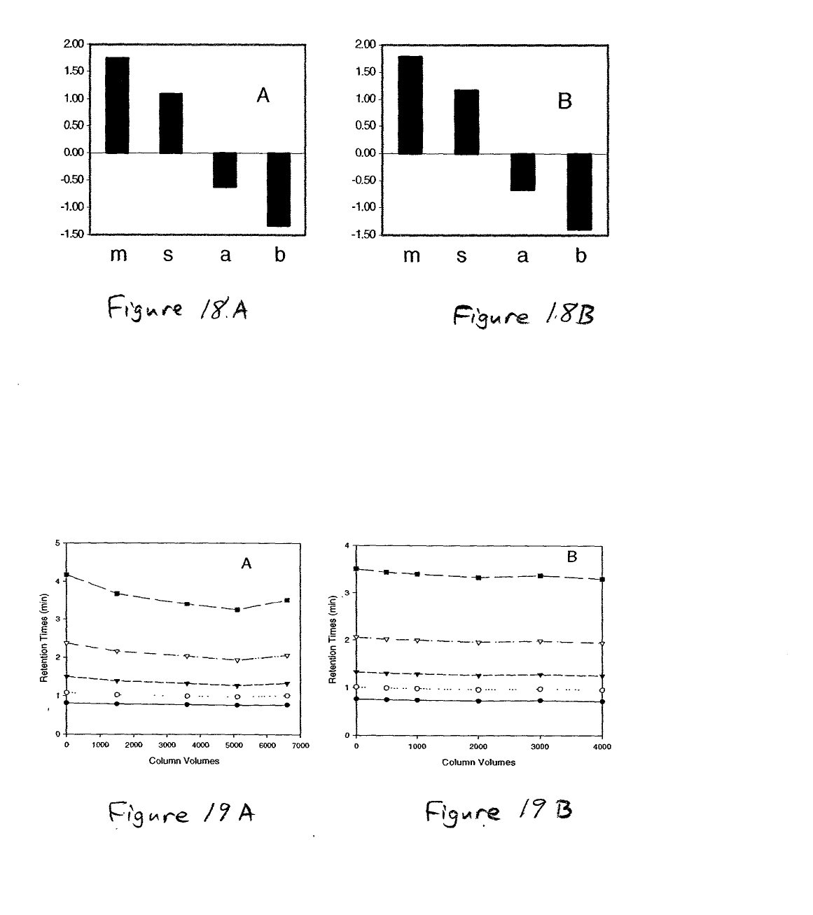

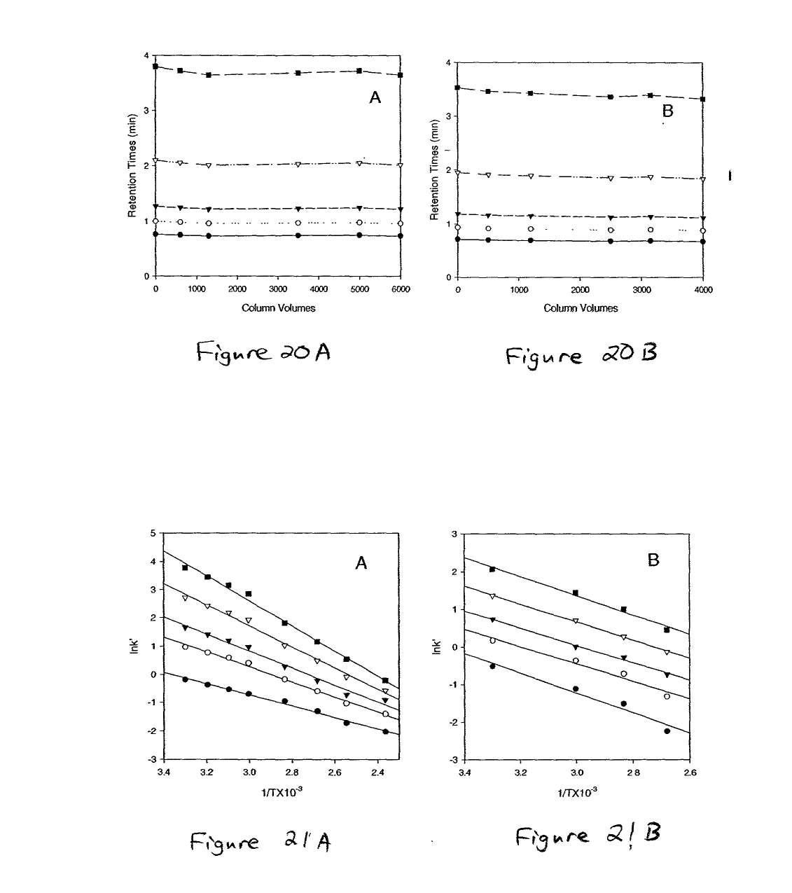

In reversed-phase liquid chromatography, elevated temperatures can significantly reduce analysis time, decrease column backpressure, and improve column efficiency. Furthermore, the use of high column temperatures may enable fast separations on conventional equipment by the use of high flow rates. In other words, the higher the temperature that can be achieved, the faster the separation can be obtained. Therefore, the thermal stability of CNPZ and polybutadiene coated-styrene modified carbon-coated nonporous zirconia (PSCNPZ) at a column temperature of 150° C. was examined. FIGS. 19A and 19B show a column stability of each column at 150° C. Both columns proved to have stable retention for at least 4000 column volumes. FIGS. 20A and 20B show that both PSCNPZ and CNPZ are chemically stable from pH 1 to 14. The acid stability of PSCNPZ and CNPZ was tested using a mobile phase of 35/65 acetonitrile/0.1 M nitric acid. The stability of these two stationary phases was studied by monitoring the retention factors of a homolog series of alkylbenzenes. Both PSCNPZ and CNPZ were found to be chemically stable after flushing both 6000 and 4000 column volumes of 0.1 M HNO₃ (FIG. 20A) and 1 M NaOH (FIG. 20B) through each column.

The thermodynamics of retention on CNPZ and PSCNPZ were compared by using the van't Hoff relationship between retention and temperature as described by the following equation.

lnk′=−ΔH°/RT+ΔS°/R+lnΦ (3)

As shown in equation 3, a plot of lnk′ versus 1/T should be a straight line with the slope equal to the enthalphy of transfer of the solute from the mobile phase to the stationary phase. FIG. 21 shows a plot of lnk′ versus temperature for CNPZ and PSCNPZ using a homolog series of alkylbenzenes. The slope of the lines on CNPZ are steeper than the slopes on PSCNPZ indicating greater exothermic enthalpy of transfer for these solutes on CNPZ than on PSCNPZ. Overall these plots of Ink′ versus 1/T showed good linearity for the temperature range studied (30° C. to 150° C.). The correlation coefficients were all greater than 0.99.

In RPLC, the effect of the organic modifier on the absolute retention factor can be approximated using Synder's linear solvent strength theory (LSST) by the following equation.

log k′=log k′w−Sφ (4)

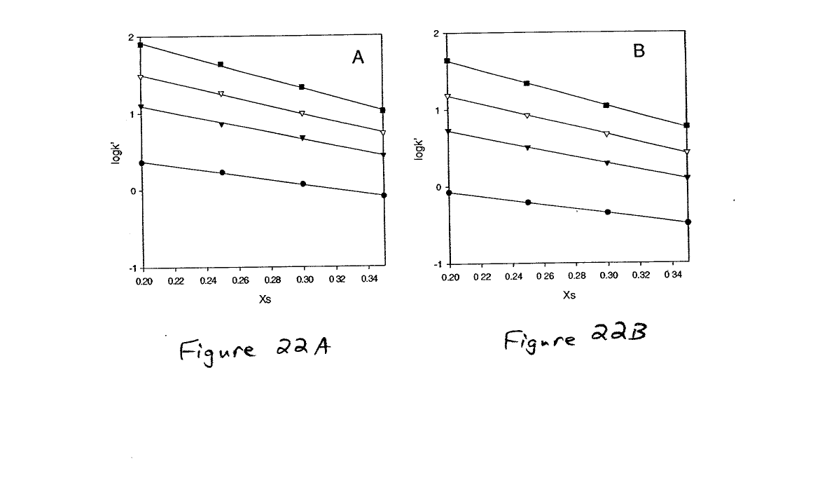

FIG. 22 shows the dependence of log k′ versus percentage of organic modifier for alkylbenzenes on PBDNPZ and CNPZ. Good linearity was found for these plots for both columns. S is the slope of these plots and is related to the chromatographic selectivity on the stationary phase. No significant differences in S (see FIG. 22 for S values) for CNPZ and PBDNPZ were found, indicating similar selectivity for these solutes under these conditions.

The chromatographic usefulness of the stationary phases developed herein (PBDNPZ, PSCNPZ, and CNPZ) were explored. Separations of three classes of compounds (phenols, cosmetics, and pesticides (triazines)) were analyzed. These separations exploit the intrinsic thermal and chemical stability of the stationary phase to do ultrafast liquid chromatography.

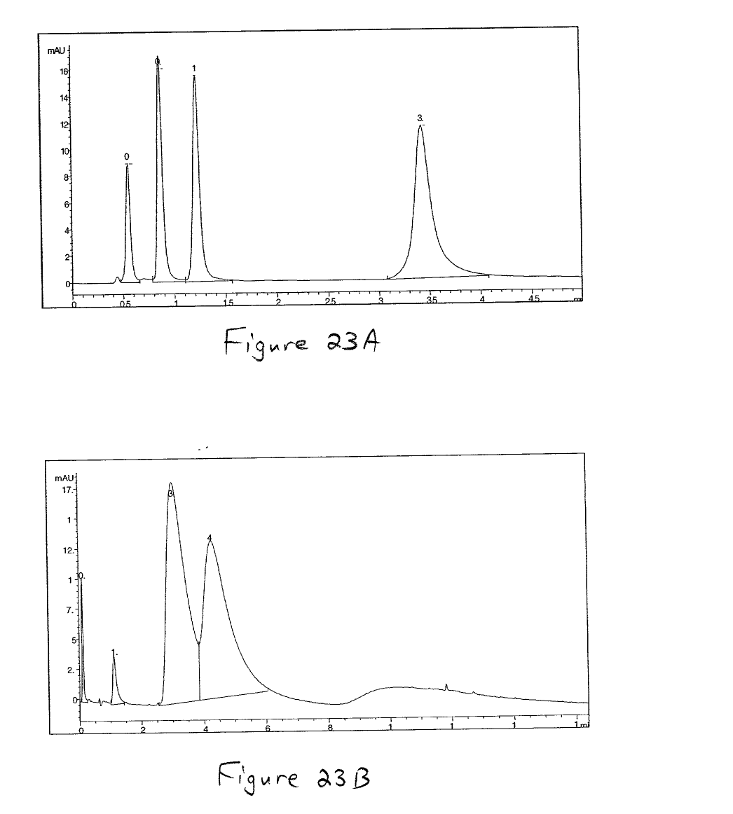

1. EPA-Priority Phenols on PBDNPZ in FIG. 23 shows the separation of four EPA-priority phenols on PBDNPZ and porous 3 μm PBD coated zirconia (commercially sold as ZirChrom-PBD). The separation obtained on PBDNPZ is far superior to that obtained on PBD coated porous zirconia in terms of resolutions, efficiency, and analysis time.

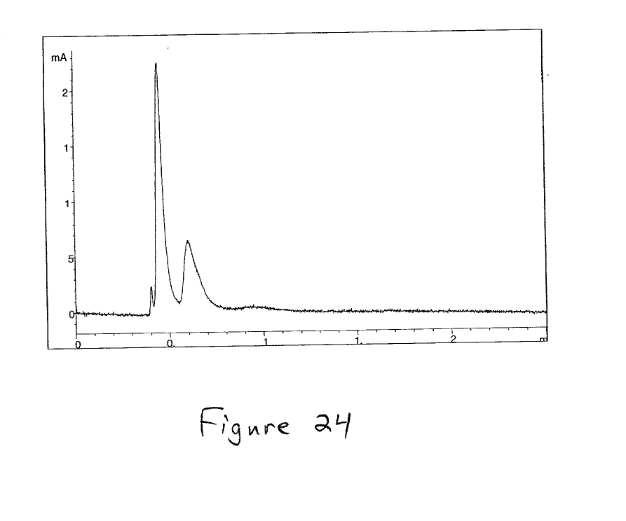

2. High Temperature Ultrafast Cosmetic Separations on CNPZ in FIG. 24 shows the fast (40 seconds) separation of cosmetics on CNPZ at 150° C. using pure water as the mobile phase.

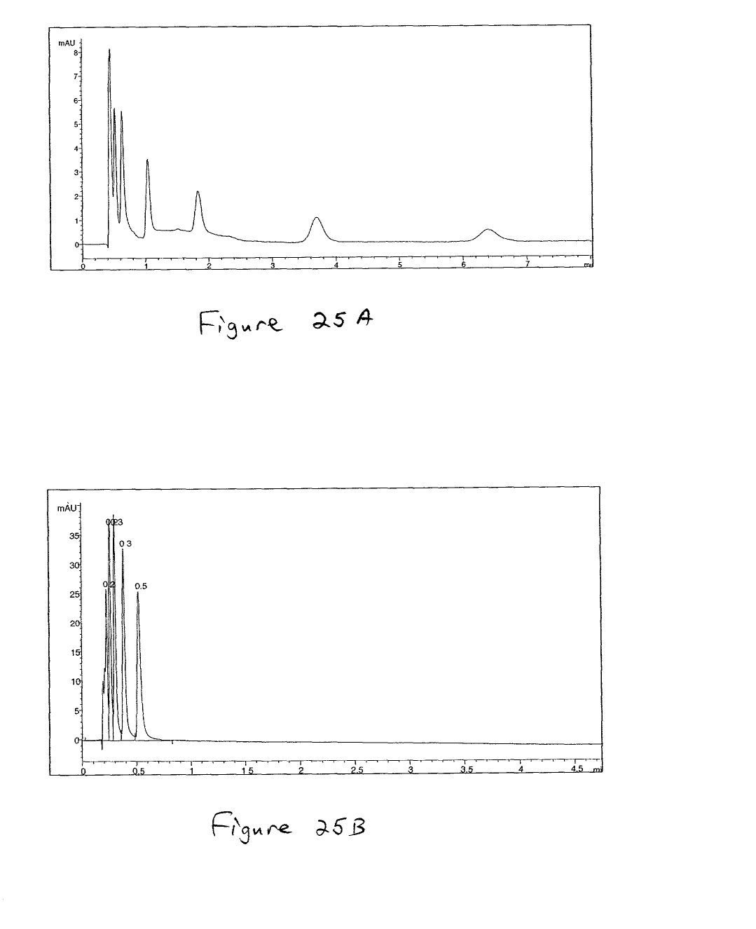

3. High Temperature Separations of Pesticides on PBDNPZ in FIG. 25 shows the separation of seven trazines pesticides on PBDNPZ at ambient and at 100° C. The separation can be achieved 15-fold faster at 100° C. versus 30° C. with almost the same resolution. Most importantly at 100° C., 100% water was used so that no hazardous is produced in the analysis.

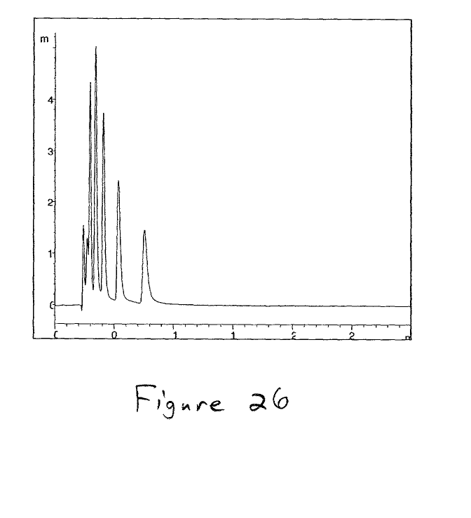

Ultrafast separation of alkylbenzenes at high flow rate (4 ml/min) and at high temperature (150° C.) on a PSCNPZ packed column was evaluated (FIG. 26).

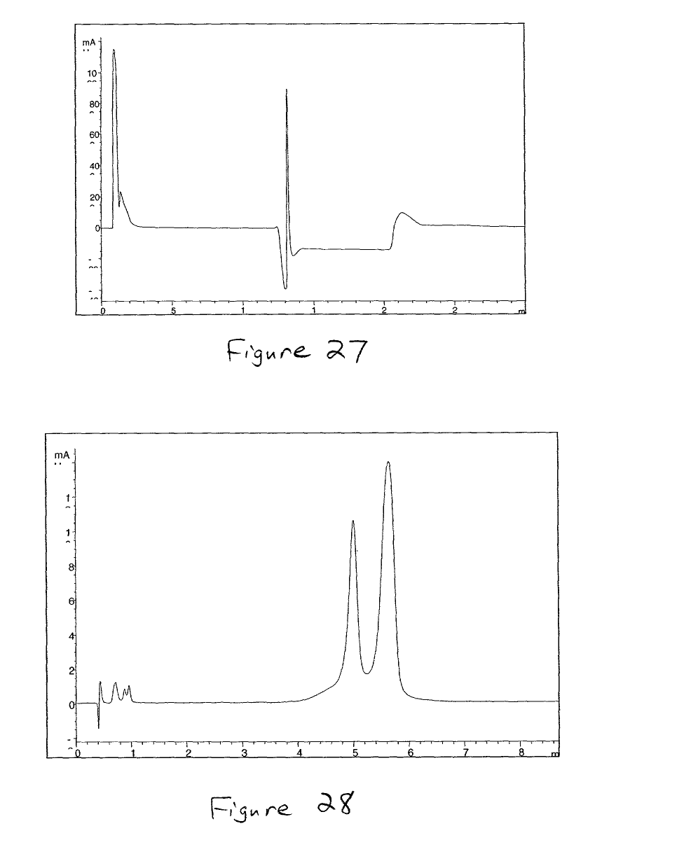

Separation of monoclonal antibodies (Ms×hPARC, clone #64509.11 from R&D Systems) was evaluated on a EDTPA-NPZ packed column (FIG. 27).

Separation of m-xylene and p-xylene isomers was evaulated on a PBDNPZ packed column (FIG. 28).

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the examples set forth herein and that such examples and embodiments are presented by way of example only with the scope of the invention intended to be limited only by the claims set forth herein as follows.

What is claimed is:

1. A method of preparing metal oxide microspheres, the method comprising:
combining a metal alkoxide, water, an organic acid or salt thereof in an organic solvent to form a reaction mixture;
allowing microspheres to form in the reaction mixture;
removing the microspheres from the reaction mixture, wherein the microspheres have a reactive gel thereon; and
washing the microspheres to remove at least a portion of the reactive gel.

2. The method of claim 1 wherein removing the microspheres from the reaction mixture comprises filtering the reaction mixture.

3. The method of claim 2 wherein removing the microspheres from the reaction mixture comprises filtering the reaction mixture without centrifuging.

4. The method of claim 1 wherein after agitating the reaction mixture, the microspheres are allowed to age.

5. The method of claim 4 wherein the microspheres are aged with slow sample movement for a time sufficient to provide the particle size desired.

6. The method of claim 5 wherein the microspheres are aged at least about 2 minutes.

7. The method of claim 4 further comprising adding anhydrous alcohol to the reaction mixture after aging.

8. The method of claim 1 wherein the organic solvent in the reaction mixture is an anhydrous alcohol.

9. The method of claim 1 wherein the metal oxide microspheres are zirconia, titania, hafnia, alumina, niobia, yttria, or magnesia microspheres, or mixed oxides thereof.

10. The method of claim 1 wherein the as-produced microspheres are substantially monodisperse and substantially unaggregated.

11. The method of claim 10 wherein the microspheres have an average particle size of about 0.1 micron to about 10 microns.

12. The method of claim 1 wherein allowing microspheres to form in the reaction mixture comprises agitating the reaction mixture.

13. The method of claim 12 wherein the reaction mixture is agitated for up to about 50 minutes after the reaction mixture becomes cloudy.

14. The method of claim 1 further including heating the washed microspheres to form substantially nonporous microspheres.

15. The method of claim 14 wherein the microspheres are initially heated at a temperature and for a time to remove substantially all the volatile organic material.

16. The method of claim 15 wherein the microspheres are initially heated at a temperature of about 100° C. to about 350° C. to remove substantially all the volatile organic material.

17. The method of claim 15 wherein in the microspheres are subsequently heated in air or oxygen at a temperature and for a time to remove substantially all the nonvolatile organic material.

18. The method of claim 17 wherein the microspheres are heated at a temperature of about 200° C. to about 1100° C. to remove substantially all the nonvolatile organic material.

19. The method of claim 17 wherein the microspheres are subsequently heated at a temperature and for a time to densify them.

20. The method of claim 19 wherein the microspheres are heated at a temperature of about 600° C. to about 1100° C. to densify them to form substantially nonporous microspheres.

21. The method of claim 19 wherein the densified microspheres are at their theoretical density.

22. The method of claim 19 wherein the nonporous microspheres have a surface area that is within a factor of three of the theoretical surface area.

23. The method of claim 1 wherein the microspheres are prepared substantially reproducibly from batch to batch.

24. A method of preparing substantially nonporous, metal oxide microspheres, the method comprising:
combining a metal alkoxide, water, a C6-C30 carboxylic acid in an alcohol to form a reaction mixture;
agitating the reaction mixture to produce microspheres;
allowing the microspheres to age;
removing the microspheres from the reaction mixture, wherein the microspheres have a reactive gel thereon;
washing the microspheres to remove the reactive gel; and
heating the washed microspheres under conditions and for a time to form substantially nonporous microspheres.

25. A method of preparing metal oxide microspheres, the method comprising:
combining a metal alkoxide, water, an organic acid or salt thereof in an organic solvent to form a reaction mixture;
allowing microspheres to form in the reaction mixture;
adding a surfactant to the reaction mixture; and
removing the microspheres from the reaction mixture.

26. Microspheres produced by the method of claim 1.

27. Microspheres of claim 26 having a carbon coating thereon.

28. Microspheres of claim 27 having an organic polymer coating thereon.

29. Microspheres of claim 26 having an organic polymer coating thereon.

30. Microspheres produced by the method of claim 24.

31. Microspheres of claim 30 having a carbon coating thereon.

32. Microspheres of claim 31 having an organic polymer coating thereon.

33. Microspheres of claim 30 having an organic polymer coating thereon.

34. Microspheres produced by the method of claim 25.

35. Microspheres of claim 34 having a carbon coating thereon.

36. Microspheres of claim 35 having an organic polymer coating thereon.

37. Microspheres of claim 34 having an organic polymer coating thereon.

38. A sample of as-produced, substantially nonporous, metal oxide microspheres having an average particle diameter of about 0.1 micron to about 10 microns with a standard deviation of no more than about 30 percent of the mean.

39. The sample of as-produced, substantially nonporous, metal oxide microspheres of claim 38 wherein the metal oxide is selected from the group consisting of zirconia, titania, hafnia, alumina, niobia, yttria, magnesia, and mixtures thereof.

40. The sample of as-produced, substantially nonporous, metal oxide microspheres of claim 38 wherein the microspheres are stable up to about pH 14 and up to at least about 150° C. in aqueous media.

41. The sample of as-produced, substantially nonporous, metal oxide microspheres of claim 38 wherein the microspheres have a carbon coating thereon.

42. The sample of as-produced, substantially nonporous, metal oxide microspheres of claim 41 wherein the microspheres have an organic polymer coating thereon.

43. The sample of as-produced, substantially nonporous, metal oxide microspheres of claim 42 wherein the organic polymer comprises polybutadiene.

44. The sample of as-produced, substantially nonporous, metal oxide microspheres of claim 42 wherein the organic polymer comprises polystyrene.

45. A chromatography device comprising:
a chromatography column; and
microspheres of claim 38.

46. The chromatography device of claim 45 wherein the metal oxide is selected from the group consisting of zirconia, titania, hafnia, alumina, niobia, yttria, magnesia, and mixtures thereof.

47. The chromatography device of claim 45 wherein the microspheres are stable up to about pH 14 and up to at least about 150° C. in aqueous media.

48. The chromatography device of claim 45 wherein the microspheres have a carbon coating thereon.

49. The chromatography device of claim 48 wherein the microspheres have an organic polymer coating thereon.

50. The chromatography device of claim 49 wherein the organic polymer comprises polybutadiene.

51. The chromatography device of claim 49 wherein the organic polymer comprises polystyrene.

52. A stationary phase material for chromatography comprising microspheres of claim 38.

53 The stationary phase material of claim 52 wherein the metal oxide is selected from the group consisting of zirconia, titania, hafnia, alumina, niobia, yttria, magnesia, and mixtures thereof.

54. The stationary phase material of claim 52 wherein the microspheres are stable up to about pH 14 and up to at least about 150° C. in aqueous media.

55. The stationary phase material of claim 52 wherein the microspheres have a carbon coating thereon.

56. The stationary phase material of claim 55 wherein the microspheres have an organic polymer coating thereon.

57. The stationary phase material of claim 56 wherein the organic polymer comprises polybutadiene.

58. The stationary phase material of claim 56 wherein the organic polymer comprises polystyrene.

59. A chromatographic column comprising a length of tubing packed with a stationary phase material comprising microspheres of claim 38.

60. The chromatographic column of claim 59 wherein the metal oxide is selected from the group consisting of zirconia, titania, hafnia, alumina, niobia, yttria, magnesia, and mixtures thereof.

61. The chromatographic column of claim 59 wherein the microspheres are stable up to about pH 14 and up to at least about 150° C. in aqueous media.

62. The chromatographic column of claim 59 wherein the microspheres have a carbon coating thereon.

63. The chromatographic column of claim 62 wherein the microspheres have an organic polymer coating thereon.

64. The chromatographic column of claim 63 wherein the organic polymer comprises polybutadiene.

65. The chromatographic column of claim 63 wherein the organic polymer comprises polystyrene.
